(19) United States
(12) Patent Application Publication
(10) Pub. No.: US 2004/0237529 A1
(43) Pub. Date: Dec. 2, 2004

(54) Methods and systems for reversibly exchanging energy between inertial and rotating forces

(76) Inventor: Elson Dias da Silva, Campinas (BR)

Correspondence Address: Kermit Lopez / Luis Ortiz, ORTIZ & LOPEZ, PLLC, Patent Attorneys, P.O. Box 4484, Albuquerque, NM, 87196-4484, US

(21) Appl. No.: 10/823,359

(22) Filed: Apr. 13, 2004

Related U.S. Application Data
(63) Continuation-in-part of application No. 10/082,370, filed on Feb. 25, 2002, now Pat. No. 6,766,817.

(51) Int. Cl. H02K 33/00

(52) U.S. Cl. 60/721

(57) ABSTRACT

Methods and systems for exchanging energy reversibly between inertial and rotating forces with a masstubarc flow siphon by non-partitioning mass flow movement are disclosed. Energy can be exchanged reversibly between inertial and rotating forces utilizing a specific geometric design that preserves longitudinal molecular connectivity. A reversible masstubarc flow siphon can be configured as a symmetric interface for the contention of mass as linear in an inertial force zone and as arc in a rotating force zone. The arc section reversibly and gradually transfers the energy between linear and rotating motions. A geometric design allows a reversible masstubarc flow siphon to function like a rotating pump that adds kinetic and/or mechanic energy to the mass. If the device changes its rotating direction, the mass flow can also change direction, thereby reversibly moving the mass. Similar to a turbine collecting energy, if the moving mass possesses a high level of inertial energy, the energy can be transferred to the rotating device in a reversible mass direction.

### CROSS REFERENCE TO RELATED PATENT APPLICATION

This patent application is a continuation-in-part of U.S. patent application Ser. No. 10/082,370, “Fluid Conduction Utilizing a Reversible Unsaturated Siphon With Tubarc Porosity Action,” which was filed on Feb. 25, 2002 and claims priority to U.S. Provisional Patent Application Serial No. 60/307,800, which was filed on Jul., 25, 2001. The disclosure of U.S. patent application Ser. No. 10/082,370 is incorporated herein by reference.

### TECHNICAL FIELD

Embodiments relate generally to energy conversion processes between inertial forces and rotating forces. Embodiments also relate to the collection of energy from natural mass flow, such as, for example, hydro-power and air power, or from artificial mass flow. Embodiments additionally relate to the use of rotating forces to move mass by pumping fluid or air, the filtering of hydro-mass and/or air mass, heat exchange, and propulsion. Embodiments also relate to the application of a spatial geometric design for lifting and/or propulsion for hydrodynamic and/or aerodynamic navigation.

### BACKGROUND OF THE INVENTION

A tube is a perfect hollow cylindrical geometric object for moving bulk fluids from one place to another. When fluids move by suction in a porous system towards a solid attraction, however, an enhanced geometric device is preferred. An example of such an enhanced geometric device, including methods ands systems thereof, is disclosed in U.S. Patent Publication No. US 2003/0160844 A1, which is incorporated herein by reference. Such a device is referred to in U.S. Patent Publication No. US 2003/0160844 A1 as a “tubarc” (pronounced tube-ark), which suggests a replacement of capillary action by providing different tube shape for specific applications of fluid delivery.

A “tubarc” can be implemented as a tube-like figure with a continuous lateral slit that runs longitudinally in the wall of the tube and forms an arc like structure for spatial containment. Indeed, a tubarc can provide a solution for unsaturated hydraulic flow conceptions, while providing a uniform and enhanced porosity, a continuous multi-directional flow of fluid, and a special alignment of voids to the longitudinal flow, thereby developing a high level of anisotropy, prevailing directional flow, and higher void rates, which are essential to many applications that require rapid and reliable delivery or contention of fluids.

The methods and systems disclosed in U.S. Patent Publication No. US 2003/0160844 A1 also discussed an important macroporosity conception referred to as a Reversible Unsaturated Hydraulic Siphon, which can be embodied as a U-shaped upside down device that connects compartments for fluid transmission functioning under gravity conditions. Such a device was specially designed to move fluids reversibly from higher to lower fluid matric potential at any direction whenever the gradient is favorable. Nevertheless, many important technical applications generally do require fluids or mass to move faster than gravity spontaneously allows.

It is believed that force from a natural or artificial moving mass can be utilized to provide a basic power source for extending the functional limitations of the Reversible Unsaturated Hydraulic Siphon or “tubarc” disclosed in U.S. Patent Publication No. US 2003/0160844 A1. Consequently, any practical solution for moving mass far beyond gravity conditions would be a welcome advancement, thereby extending the boundaries of functional applications beyond the disclosure of U.S. Patent Publication No. US 2003/0160844 A1.

Filtering technology represents applications that require a rapid flow in order to deliver a great load of required work. A high volume of fluid can be filtered through via “tubarc” porosity by utilizing an unsaturated hydraulic siphon if external forces are applied to a moving fluid mass to permit the flow process to run quickly. The problem is highly complex because “pushing” the fluid toward a filter may lead to constant clogging, because of the presence of pressure seal porosity pores and particles impurities. Alternatively, “pulling” the fluid may not be feasible because the partitioning of pumping systems can break molecular connectivity and impair suction prospective.

A reversible unsaturated hydraulic siphon, when appropriately assembled to a rotating device, can gain inertial force by increasing its mechanic/kinetic energy without any partitioning in the mass flow movement. In such a situation, the inertial force can be supplied by rotating devices, thereby delivering faster fluid movement and improving the overall applications of high precision fluid delivery. External forces can be supplied directly or indirectly from moving mass such as, for example, rivers, wind, or the chemical energy of organic compounds. Consequently, inertial forces supplied by rotating devices are better designated as rotating forces. Then filtering process velocity can then increase not by “pushing” or “pulling” the mass through the filter or filtering device, but by simply adding the required mechanic/kinetic energy directly to the filtering device. In essence, the filtering system or device functions as a pump, which forces the mass to pass through the filtering system. Such a configuration may function as a filter that pumps, or a pump that filters.

Thus, the same reversible unsaturated hydraulic siphon for unsaturated fluid transmission disclosed in U.S. Patent Publication No. US 2003/0160844 A1 can be employed as an enhanced tubular structure of contention, which possesses a special geometric design for converting energy from rotating forces to inertial forces. Such a configuration may offer important features for fluid dynamics regarding molecular connectivity, which can be preserved in a full extent by the tubular containment, which is disclosed in greater detail herein.

A siphon that connects rotating forces to linear forces can be referred to herein generally as a “Reversible Masstubarc Flow Siphon,” which generally provides the interface between a linear tube for inertial forces and an arc of the tube for rotating forces. Such an interface represents an important system and method for converting reversibly rotating and inertial forces of a moving mass. The arrangement, shape, and dimensions of the arc in the rotating device may vary according to the dynamics and properties of the moving mass as well as to the level of energy exchange expected for each application.

More efficient methods and systems for converting energy from inertial forces to rotating forces and vice-versa are highly desirable for filtering, pumping, propulsion, combustion engines, fans, vanes, windmills, turbines, and many other applications of energy dynamics. Efficiency is not only critical for saving energy, but also for improving environmental conditions necessary for human existence, as well as curbing noise, air and water pollution, and preserving natural resources. A type of environmental balance can be achieved when harmony occurs between energy expenditures and energy collection in a renewable cycle.

The sun provides the most basic source of energy, which is constantly converted to thermal and subsequently motion energy in winds and running rivers through the global circulation system. The spatial and temporal dynamics of such sources of energy are highly understood because the marching of the seasons annually provides an alternating amount of heat to the northern and southern hemispheres interchangeably. Rainy seasons provide a peak for watershed recharge which permits the rivers to continue toward the ocean, as well as ensuring that the winds blow constantly to prevailing directions. Such sources of inertial energy are highly reliable and have been utilized in the development of windmills, waterwheels, wind sailing, and the like.

An important portion of sun energy is constantly converted to biomass in the biochemical photosynthetic processes of plants. Most human development relies on the use of such energy, which were stored eons ago in the chemical reactions of carbonic molecules of fossil fuels. Changing the process of energy conversion for use as a solid biomass could positively affect the outcome of human development when non-renewable energy sources are expected to generally expire in few decades. It is expected that humans will eventually rely upon energy sources that are renewable, sound, and environmentally-friendly.

A continuous mass flow system in the combustion of engines can withstand the ash content of biomass, which usually varies at approximately 6% of its organic matter composition, as well as a higher temperature required for complete combustion and faster rotating speed to improve energetic conversion efficiency. Perhaps, even rice straw, which can attain up to 20% of mineral composition associated to the concentration of silicates in the dry matter, would function. A simple rotating element in a gas pipe outlet can collect the releasing ash of a biomass burning. The collected ash could be reused in farmlands as fertilizer, thereby returning plant nutritional elements sequestered with this renewable fuel. In such a situation, only part of the volatile nutritional minerals such as nitrogen and sulfur would be wasted in the energy cycle of transferring energy from organic matter of renewable fuel to general rotating machinery.

The energy balance of a combustion engine is in many ways similar to the dynamics of input/output utilized in animal nutrition, and can be utilized as basis for assessing the energetic balance of biological systems. Ethanol, for example, has approximately 6.4 Kcal/g of gross energy; while petroleum derived fuels possess approximately 10 Kcal/g of gross energy. Biomass energy content is approximately 4.4 Kcal/g, while pure fat reaches 9 Kcal/g. Because the present thermal efficiency of combustion engines varies from approximately 20% to 40%, a biomass combustion engine, which is disclosed herein with respect to particular embodiments, has the potential to deliver the same compensatory performance, thereby increasing its thermal efficiency.

Combustion engines utilizing a continuous mass flow system could deliver reduced losses of energy and an enhanced approach for converting inertial to rotating forces. For example, a biomass engine having a 60% to 80% of efficiency could deliver the same power of a combustion engine that runs on petroleum fuels. Considering that biomass is a worldwide renewable source of energy, then a harmonious solution to the energy cycle to attend human affairs can be fully attained. Such an improved thermal efficiency also could provide for the longer lasting use of non-renewable fossil fuels, while allowing more time for technological development and adjustments.

Many other advantages and options can be considered, such as combining the use of fat substances as liquid fuel that possess a higher ratio of gross energy approximating that of fossil fuels. Another very important factor to consider is that a biomass engine does not contain moving parts, other than rotating about itself through an axis to produce a smaller and lighter vehicle load. Also, the burning temperature is practically limitless because moving parts are not present within the engine, which effectively comprises merely a burning chamber and an outlet for energy harvesting. The standard temperature for chemical analysis of ash varies from 500 to 700°0 C. during which organic matter can be burned to release its mineral composition. This means that the temperature rising above such a threshold range would gain combustion efficiency and be restricted to the surface area of solid particles and for exposing carbon matter during burning reactions.

Nature allows by principles many possible solutions with varied results to a unique problem. Human limitation to find the most appropriate solutions is just an improving process to our understanding of nature functioning in the long haul. The philosophy of science has demonstrated that nature is endowed with a high level of symmetry in its broad and complex functioning. Then, constantly new solutions come easily at hand as technology development provides new and enhanced tools or ways for advancement. A perfect symmetric rotating device would pump mass reversibly in any direction by just changing its rotating direction, clockwise or counterclockwise. Then, kinetic/mechanic energy is converted in the process of moving mass. A moving mass may have its kinetic/mechanic energy converted back as rotating energy. Consequently, this same rotating device would work reversibly as a turbine, or windmill, or waterwheel collecting energy as the mass moves through it in any direction, or releasing kinetic/mechanic energy to the rotating device. As the efficiency increases, reduced losses approach would provide guidance toward enhancement in the process of energy conversion between inertial and rotating forces. Conclusively it is not a question whether it works, but on how to make it work always in improved growing levels for a broad range of technological applications. The achievable results are expected to have always further improved ones as the boundaries of restrictions and limitations are continuously lowered by development. This chain of logically connected principles never fails if nature balance is due respected and wisely followed.

Waterwheels resemble the most basic ancient way of converting inertial/kinetic energy to rotational energy of a running river. This basic principle of partitioning the mass flow in a wheel still is the basic fundamental prevailing today in the broad energy conversion system in use. The mass flow is partitioned to small portions and the energy is collected by the continuous mass slicing process. The opposite also occurs to almost all regular pumping system. But, Instead of collecting energy, the pumping operation adds energy to sequestered portions of the mass. The pumping system follows a similar approach, in which a part of the mass is partitioned from the main moving mass and squeezing power is applied to it, resulting in a higher level of kinetic/mechanic energy. Even the centrifugal/centripetal pumps can make a continuous slicing to the mass by rotating runners or vanes as it increases the potential energy to the moving mass outwardly from the center.

The partitioning process spoils a very basic principle of molecular connectivity of fluids that has not been assessed well enough to date in fluid mechanical arts. A simple analogical approach can provide deep insights into the importance of the adhesion-cohesion force. For example, when analyzing a mass flow process in a piping system at a microscopic level, connectivity of bonding molecules shows an important feature for consideration. Such a process can be observed, for example, when a leaking faucet drips water in intermittent drops. Water leaking from cracks or fissures, however, leaks in a continuous process. The fluid has a high adhesion-cohesion, which grows sufficiently larger until it attains a weight sufficient to permit the fluid to fall out of the faucet as an enormous droplet repeatedly.

A four millimeter water droplet hanging from a horizontal surface can possess approximately 12 million molecules in a vertical chain. By way of analogy, if each molecule were the size of car train of 30 m, then the molecules would make up a train composition chain of 360 million meters long, or 360 thousand kilometers. Such a configuration is sufficiently long to circle the earth approximately nine times. Such an analogy can provide insights into the level of existing energy associated with the bounding of molecules in a mass flow. Such a configuration was addressed by the “Tubarc” device described and illustrated in U.S. Patent Publication No. US 2003/0160844 A1, which indicated that the connectivity of fluids can move via unsaturated flow through a geometrically enhanced porous systems.

The volume of a water droplet, if stretched within a Tubarc structure of approximately a 5:m diameter could attain 853 m. If such a volume were smaller, however, such as 1:m diameter, it could attain approximately 21.3 km. Consequently, any system that handles mass flow that does not disturb molecule connectivity should be more efficient when it comes to saving energy and preventing side effect disturbances such as, for example, noise, turbulence, cavitations, bubbling, overheating, losses of pressure or suction, and so forth. Not only could energy be spared through the use of such an enhanced system, but a large reduction in noise pollution would also likely result

The Molecular connectivity of a mass is highly evident when assessing fluvial hydrology. Water velocity of a running river is not uniform in all sections, because its flow reduces toward the bottom and margins of a river near the containment borders, consequently developing the highest speed in the upper center of the running river. This phenomenon occurs because the containing boundaries of the river are stationary, thereby adding dragging power to the moving mass of water, which possesses a high level of molecular connectivity in the fluid dynamics thereof. A river is a large natural containment of mass moving toward the ocean or any other water body. This sort of containment functions openly and under the force of gravity, and is therefore highly affected by molecular connectivity. If the stationary containment boundaries maintain the moving mass, on the other hand, then a fast moving boundary of a reversible masstubarc siphon tube would also drag the moving fast toward a faster velocity

A rope pump may be the type of device that can move fluids as mass flow, without partitioning and/or taking advantage of water connectivity, as for example, viscosity. Such a device, however, has not improved enough due to the lack of fluid spatial contention. Consequently, such a device functions properly only at gravity conditions. Fluid spatial contention would permit faster speeds because it would withstand higher suction and pressure preserving molecular bounding in the bulk flow. Providing fluid spatial contention to a moving mass with no partitioning would allow for a faster exchange of energy by a rotating mechanism. It is important to note that the addition of a fast molecular bounding propagation of kinetic/mechanical energy, such as suction and pressure, is highly dependent upon molecular connectivity of the moving mass in the fluid dynamics, upward and downward in the mass potential range.

Fluid spatial contention becomes a suitable solution in the process of transferring energy from rotating forces to inertial forces in order to preserve molecular connectivity. An appropriate design would render such an approach reversible, thereby curbing major energetic losses while providing functional simplicity. A geometric design solution to transform inertial forces to rotating forces reversibly was not yet been delineated or implemented. If such a design could be achieved, mass moving from one location to another could deliver or receive energy from a rotating force. A moving mass flow, natural or artificial, could potentially have its inertial energy converted to rotating energy utilizing the same reversible mechanism principle with minimal losses possible.

Present machines that transform the chemical energy of carbonic fuel to mechanical energy have not yet attained efficiency in preventing losses from overheating, noise, and functioning restrictions. The nature of the fuel, as well as mechanical functioning associated with the partitioning of mass principles, requires devices such as valves to open and close in continuous cycles, wherein pistons expand, and crankshafts turn. Internal combustion engines utilize the same principles of the ancient waterwheel, which worked with partitioned mass flow to harvest energy from the expanding air of burning fuel and transform such energy into mechanical energy. Internal combustion engines are highly restricted to liquid fuel, and the complex mechanics of partitioning, pressurizing, sparking, and the release of gas, which initially generates inertial energy for conversion to rotating energy has a highly inefficient dynamic functioning. Such engines are therefore cumbersome and heavy; resulting ultimately in vehicles that waste energy and are destructive toward the environment because of their consumption of now-renewable energy sources (e.g., petroleum).

Additionally, due to excessive movement of mechanical parts of internal combustion engines, overheating can spoil engine functioning, which can force moving parts to melt and also for impair the proper action of their respective roles within the engine. The process of burning fuel, liquid or solid, can transform chemical energy from the bonding of organic mass directly to rotating energy by an efficiently transforming the inertial energy of expanding gases from combustion energy to rotating energy. Engines that operate on organic solid fuel could benefit in their combustion process as the temperature attains higher levels.

A very efficient combustion engine would convert nearly all chemical bonding energy of the biomass to mechanical rotating energy by expansion of gases in the burning process. Such a situation is similar to a simple pressurized oven-like device with an outer layer for thermal insulation and a spark plug for a continuous source of ignition as required. An enhanced turbine in the outlet would collect energy from expanding hot air derived from the combustion of biomass, while also pumping air and/or liquid/solid fuel to feed the engine continuously and thereby generate mechanical rotating power. The energy released from the liquid or solid fuel should provide near the same rotating power. A simple rotating device in the gas pipe exit would keep the ash from the solid fuel not to be expelled openly to the environment. In general biomass has around 6% of ash content in the organic matter.

Stone Age Man invented oil lamps approximately 70,000 years ago and quickly began to burn liquid fuel. Modern combustion engines still rely on liquid fuel because such mechanisms were not designed to accept solid fuel, such as firewood, charcoal, paper, sawdust, etc. It therefore does not make much sense, for example, for a farmer relying upon firewood as a source of energy to purchase fossil fuel, which is non-renewable and typically obtained from distant sources (e.g., the Middle East). Fossil fuel sources of energy (e.g., oil) presently in use have a predicted and ensured deadline for exhaustion. If an engine system accepts solid fuel, however, it is conceivable that farm biomass could rapidly become a valuable fuel commodity for people living in urban areas. For example, a simple grinding device attached to farm machinery would allow a farmer to feed the machinery engines with a varied source of burning biomass such as firewood, cornstalks, straws, sawdust, trimmed branches, mowed grass, etc. The burning biomass surplus could become a valuable and optional resource, thereby increasing the feasibility of farming operations that have become stagnant and over-dependent upon government subsidies.

It is therefore believed that the exchange of energy between inertial forces to rotating forces by moving mass can be achieved with reversible direction of mass movement as well as by adding or removing energy from or to it utilizing an enhanced geometry of a masstubarc flow siphon, as described herein, which provides continuous molecular connectivity.

### BRIEF SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is therefore one aspect of the present to provide methods and systems for exchange the energy of mass flow between inertial and rotating forces.

It is another aspect of the present invention to provide a specific physical geometric containment for dynamically and reversibly harvesting the kinetic energy of a moving mass.

It is another aspect of the present invention to provide a specific physical geometry of containment for dynamically and reversibly adding the kinetic energy of a moving mass.

It is another aspect of the present invention to provide methods and systems for changing the direction of a moving mass, while maintaining molecular connectivity and preventing turbulence.

It is yet another aspect of the present invention to provide methods and systems for combustion engines working with a non-partitioning mass flow of burning liquid and/or solid fuel.

It is another aspect of the present invention to provide a propulsion system that can be adapted for use with for airplanes, rockets, ships, and/or other vehicles.

It is still another aspect of the present invention to provide for improved navigation dynamics associated with moving vehicles, resulting in airlift and stability via an unbalanced mass flow siphon.

It is a further aspect of the present invention to provide a reliable solution for reversibly transporting mass from a point of origin to a point of destination.

It is another aspect of the present invention to provide efficient methods and system of performing continuous mass filtration.

It is an additional aspect of the present invention to provide a particular dynamic functioning of a reversible windmill.

It is yet another aspect of the present invention to provide an improved turbine functioning by non-partitioning mass flow using a masstubarc flow siphon.

It is still another aspect of the present invention to provide a safe reversible siphon for heat exchange.

It is a further aspect of the present invention to provide for a non-turbulent method and system for altering mass direction.

The above and other aspects are achieved as is now described. A method and system for exchanging energy between inertial forces and rotating forces with a reversible masstubarc flow siphon by non-partitioning mass flow is disclosed herein. Mass can be conducted from one place to another reversibly absorbing or delivering mechanical energy from a rotating device. The reversible masstubarc flow siphon bears an optimum spatial geometry to allow a conversion between inertial energy and rotating energy preserving molecular connectivity in the non-partitioning of mass flow. The rounding geometry of the masstubarc is flexible to offer several level of pressure or suction aimed since the format can have a neutral design which would offer velocity zero and increasing parameter according to the change of shape by balancing the distribution of inward and outward forces acting in the rounding part of the siphon.

The mass is dynamically transportable through the reversible masstubarc flow siphon absorbing and/or delivering energy with reversible flow.

The reversible masstubarc flow siphon disclosed herein can, for example, be formed as a containing structure, preferentially tubular and uniform dimensions, having two linear sides associated to the inertial forces joined by a rounding arc part which is the main interface with the rotating forces in order to gather or deliver rotating energy to/from inertial forces.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a cross-sectional view of a dynamic modeling of mass flow potential to assess the pumping problem, in accordance with a preferred embodiment of the present invention;

FIG. 2 illustrates a cross-sectional view of a dynamic model illustrative of molecular connectivity of unsaturated hydraulic flow in transversal and longitudinal directions of prevailing applied gravitational force, in accordance with a preferred embodiment of the present invention;

FIG. 3 illustrates a cross-sectional view of a dynamic geometric model with molecular connectivity of saturated hydraulic flow reducing flow velocity outwardly inside a tube containment due to stationary walls, in accordance with a preferred embodiment of the present invention;

FIG. 4A illustrates a cross-sectional view of a dynamic geometric modeling application of a nonreversible unbalanced masstubarc flow siphon to exchange energy between inertial and rotating forces by non-partitioning mass flow movement, in accordance with a preferred embodiment of the present invention;

FIG. 4B illustrates a cross-sectional view of a dynamic geometric modeling application of a reversible unbalanced masstubarc flow siphon to exchange energy between inertial and rotating forces by non-partitioning mass flow movement, in accordance with a preferred embodiment of the present invention;

FIG. 4C illustrates a cross-sectional view of a dynamic geometric modeling application of a nonreversible linear masstubarc flow siphon to exchange energy between inertial and rotating forces by non-partitioning mass flow movement, in accordance with a preferred embodiment of the present invention;

FIG. 4D illustrates a cross-sectional view of a dynamic geometric modeling application of a reversible arc masstubarc flow siphon to exchange energy between inertial and rotating forces by non-partitioning mass flow movement, in accordance with a preferred embodiment of the present invention;

FIG. 4E illustrates a cross-sectional view of a dynamic geometric modeling application of a reversible spiral masstubarc flow siphon for exchanging energy between inertial and rotating forces by non-partitioning mass flow movement, in accordance with a preferred embodiment of the present invention;

FIG. 4F illustrates a cross-sectional view of a dynamic geometric modeling application of a reversible circle masstubarc flow siphon for-exchanging energy between inertial and rotating forces by non-partitioning mass flow movement, in accordance with a preferred embodiment of the present invention;

FIG. 4G illustrates a cross-sectional view of a dynamic geometric modeling application of a reversible masstubarc flow siphon in circle booster to exchange energy between inertial and rotating forces by non-partitioning mass flow movement, in accordance with a preferred embodiment of the present invention;

FIG. 4H illustrates a cross-sectional view of a dynamic geometric modeling application of a reversible spring-like masstubarc flow siphon for exchanging energy between inertial and rotating forces by non-partitioning mass flow movement, in accordance with a preferred embodiment of the present invention;

FIG. 5 illustrates a cross-sectional view of a spatial modeling of a pair of nonreversible and linear masstubarc flow siphons assembled to a rotating device for exchanging energy between inertial and rotating forces by non-partitioning flow movement, in accordance with a preferred embodiment of the present invention;

FIG. 6A illustrates a cross-sectional view of a dynamic spatial modeling application of a pair of reversible and curvilinear masstubarc flow siphons assembled to a rotating device by adding energy, splitting molecules apart, and increasing velocity to the mass in order to exchange energy between inertial and rotating forces by non-partitioning flow movement, in accordance with a preferred embodiment of the present invention;

FIG. 6B illustrates a cross-sectional view of a dynamic spatial modeling application of a pair of reversible and curvilinear masstubarc flow siphons assembled to a rotating device by removing energy, colliding molecules together, and decreasing velocity to the mass in order to exchange energy between inertial and rotating forces by non-partitioning flow movement, in accordance with a preferred embodiment of the present invention;

FIG. 7A illustrates a cross-sectional view of a spatial dynamic geometry of a pair of reversible and curvilinear masstubarc flow siphons assembled to a rotating device as outward flow for exchanging energy between inertial and rotating forces by non-partitioning flow movement, in accordance with a preferred embodiment of the present invention;

FIG. 7B illustrates a cross-sectional view of a spatial dynamic geometry of a pair of reversible and curvilinear masstubarc flow siphons assembled to a rotating device as inward flow for exchanging energy between inertial and rotating forces by non-partitioning flow movement, in accordance with a preferred embodiment of the present invention;

FIG. 8 illustrates a cross-sectional view of a tangential geometric modeling of a leg of reversible masstubarc flow siphon for exchanging energy between inertial and rotating forces by non-partitioning flow movement, in accordance with a preferred embodiment of the present invention;

FIG. 9 illustrates a lateral view of a simple molecular rotating pump core functioning and mass balance dynamics with nonreversible masstubarc flow siphon by non-partitioning flow movement, in accordance with a preferred embodiment of the present invention;

FIG. 10A illustrates a cross-sectional longitudinal view of a spatial modeling application of a multiple parallel reversible and curvilinear masstubarc flow siphon in a double wheel serial module in order to exchange energy between inertial and rotating forces by non-partitioning flow movement, in accordance with a preferred embodiment of the present invention;

FIG. 10B illustrates a cross-sectional longitudinal view of a spatial modeling application of a high velocity booster to exchange energy between inertial and rotating forces by non-partitioning flow movement, in accordance with a preferred embodiment of the present invention;

FIG. 10C illustrates a cross-sectional longitudinal view of a spatial modeling application of a linear non-reversible masstubarc flow siphon to exchange energy between inertial and rotating forces by non-partitioning flow movement, in accordance with a preferred embodiment of the present invention;

FIG. 10D illustrates a cross-sectional view of a spatial modeling application of a multiple parallel masstubarc flow siphon as neutral force design wheel for counterclockwise direction to exchange energy between inertial and rotating forces by non-partitioning flow movement, in accordance with a preferred embodiment of the present invention;

FIG. 10E illustrates a cross-sectional view of a dynamic spatial modeling application of a multiple parallel reversible and curvilinear masstubarc flow siphon in spiral to exchange energy between inertial and rotating forces by non-partitioning flow movement, in accordance with a preferred embodiment of the present invention;

FIG. 10F illustrates a cross-sectional view of a dynamic spatial modeling application of a multiple parallel reversible and curvilinear masstubarc flow siphon in two pairs to exchange energy between inertial and rotating forces by non-partitioning flow movement, in accordance with a preferred embodiment of the present invention;

FIG. 10G illustrates a cross-sectional view of a dynamic spatial modeling application of a multiple parallel reversible and curvilinear masstubarc flow siphon in six pairs to exchange energy between inertial and rotating forces by non-partitioning flow movement, in accordance with a preferred embodiment of the present invention;

FIG. 11 illustrates a lateral view of a dynamic spatial modeling application of a multiple serial reversible masstubarc flow siphon in a spring-like assembly for exchanging energy between inertial and rotating forces by non-partitioning flow movement, in accordance with a preferred embodiment of the present invention;

FIG. 12A illustrates a cross-sectional horizontal view of a spatial modeling of a reversible molecular rotating pump with masstubarc flow siphon by non-partitioning flow movement, in accordance with a preferred embodiment of the present invention;

FIG. 12B illustrates a cross-sectional horizontal view of a spatial modeling of optional adding pumping modules to a reversible molecular rotating pump with masstubarc flow siphon by non-partitioning flow movement, in accordance with a preferred embodiment of the present invention;

FIG. 13A illustrates a cross-sectional horizontal view of a dynamic modeling application of a reversible molecular rotating booster pump with reversible masstubarc flow siphon by non-partitioning flow movement, in accordance with a preferred embodiment of the present invention;

FIG. 13B illustrates a cross-sectional horizontal view of a dynamic modeling of optional adding pumping modules to a reversible molecular rotating booster pump with reversible masstubarc flow siphon by non-partitioning flow movement, in accordance with a preferred embodiment of the present invention;

FIG. 14A illustrates a cross-sectional horizontal view of an enhanced dynamic modeling application to reversible fluid filtering system using molecular rotating pump with masstubarc flow siphon and unsaturated hydraulic siphon by non-partitioning flow movement, in accordance with a preferred embodiment of the present invention;

FIG. 14B illustrates a cross-sectional horizontal view of an enhanced dynamic modeling application of optional adding pumping modules to reversible fluid filtering system using molecular rotating pump with masstubarc flow siphon and unsaturated hydraulic siphon by non-partitioning flow movement, in accordance with a preferred embodiment of the present invention;

FIG. 15A illustrates a horizontal cross-sectional overview of a dynamic modeling application of a heat exchanging system using reversible molecular rotating pump with masstubarc flow siphon by non-partitioning flow movement, in accordance with a preferred embodiment of the present invention;

FIG. 15B illustrates a horizontal cross-sectional overview of a dynamic modeling of optional adding pumping modules to a heat exchanging system using reversible molecular rotating pump with masstubarc flow siphon by non-partitioning flow movement, in accordance with a preferred embodiment of the present invention;

FIG. 16A illustrates a lateral view of a spatial dynamic modeling of forces of an unbalanced reversible masstubarc flow siphon to exchange energy between inertial and rotating forces by non-partitioning flow movement for navigation, in accordance with a preferred embodiment of the present invention;

FIG. 16B illustrates a lateral view of spatial dynamic modeling of forces of an unbalanced reversible masstubarc flow siphon to exchange energy between inertial and rotating forces by non-partitioning flow movement for energy harvesting, in accordance with a preferred embodiment of the present invention;

FIG. 17A illustrates a lateral view of a spatial geometric modeling of unbalanced reversible masstubarc flow siphons in parallel upward pull assembly to exchange energy between inertial and rotating forces by non-partitioning flow movement for perpendicular traction, in accordance with a preferred embodiment of the present invention;

FIG. 17B illustrates a lateral view of a spatial geometric modeling of unbalanced reversible masstubarc flow siphons in a bulky parallel upward pull assembly to exchange energy between inertial and rotating forces by non-partitioning flow movement for perpendicular traction, in accordance with a preferred embodiment of the present invention;

FIG. 17C illustrates a lateral view of a spatial geometric modeling of unbalanced reversible masstubarc flow siphons in serial continuous upward pull assembly to exchange energy between inertial and rotating forces by non-partitioning flow movement for perpendicular traction, in accordance with a preferred embodiment of the present invention;

FIG. 17D illustrates a lateral view of a spatial geometric modeling of unbalanced reversible masstubarc flow siphons in serial intermittent downward pull assembly to exchange energy between inertial and rotating forces by non-partitioning flow movement for perpendicular traction, in accordance with a preferred embodiment of the present invention;

FIG. 18A illustrates a cross-sectional view of a spatial geometric modeling of an unbalanced reversible masstubarc flow siphon in parallel assembly to change direction of inertial forces by non-partitioning flow movement, in accordance with a preferred embodiment of the present invention;

FIG. 18B illustrates a cross-sectional view of a spatial geometric modeling of a traditional turbulent systems compared to unbalanced nonreversible and linear masstubarc flow siphon in parallel assembly to change direction of inertial forces by non-partitioning flow movement, in accordance with a preferred embodiment of the present invention;

FIG. 19A illustrates a lateral view of a spatial geometric modeling of a fan with an unbalanced reversible masstubarc flow siphon in parallel assembly to change direction of inertial forces by non-partitioning flow movement, in accordance with a preferred embodiment of the present invention;

FIG. 19B illustrates a downward view of a spatial geometric modeling with tangential correction of a fan with an unbalanced reversible masstubarc flow siphon in parallel assembly to change direction of inertial forces by non-partitioning flow movement, in accordance with a preferred embodiment of the present invention;

FIG. 20 illustrates a cross-sectional view of a spatial geometric modeling of a molecular windmill utilizing an unbalanced reversible masstubarc flow siphon with non-partitioning flow movement, in accordance with a preferred embodiment of the present invention;

FIG. 21 illustrates a cross-sectional view of a spatial geometric modeling of a molecular turbine utilizing an unbalanced reversible masstubarc flow siphon with non-partitioning flow movement, in accordance with a preferred embodiment of the present invention;

FIG. 22 illustrates a cross-sectional view of a spatial geometric modeling of a molecular turbine utilizing a balanced reversible masstubarc flow siphon with non-partitioning flow movement, in accordance with a preferred embodiment of the present invention;

FIG. 23 illustrates a lateral view of a spatial geometric modeling of a molecular propulsion system utilizing a multiple reversible masstubarc flow siphon by non-partitioning mass flow movement for aerodynamic and hydrodynamic applications in accordance with a preferred embodiment of the present invention; and

FIG. 24 illustrates a cross-sectional view of a spatial geometric modeling of a molecular combustion engine utilizing a reversible masstubarc flow siphon by non-partitioning mass flow movement for solid and liquid fuel, in accordance with a preferred embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

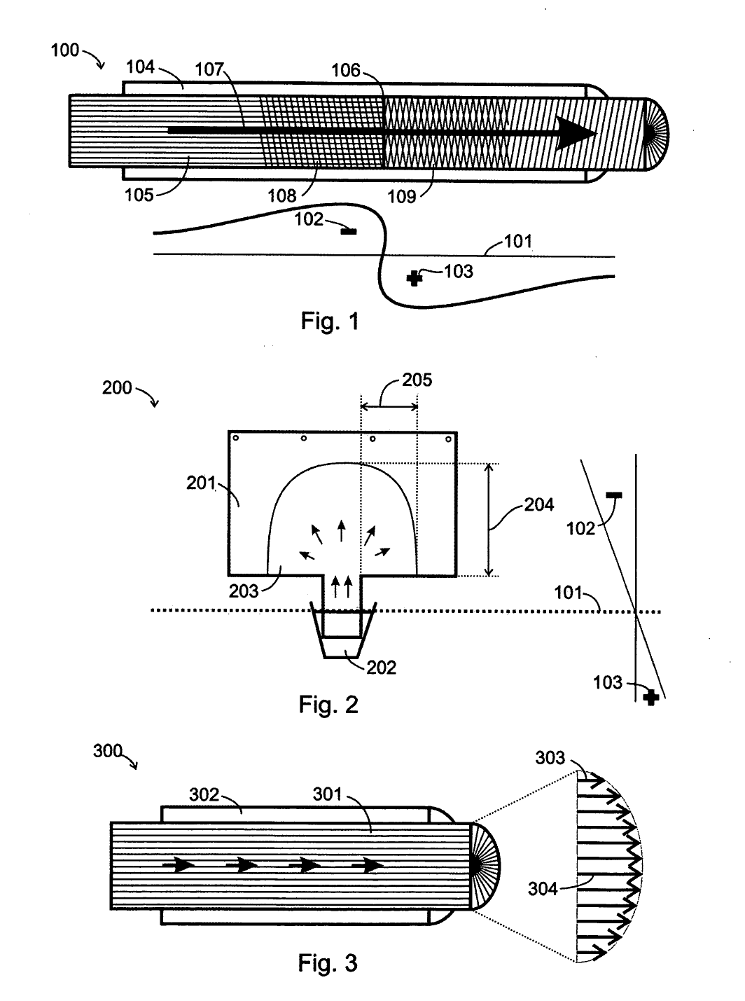

With reference now to FIG. 1, there is demonstrated a basic principle of mass transport, particularly with respect to the addition of kinetic/mechanical energy to a moving mass without affecting bulk movement volume in order to preserve molecular connectivity, chiefly in a longitudinal direction in order to achieve a smooth translocation effect. The configuration of FIG. 1 therefore demonstrates the reversal of the problem involved in harvesting energy from a moving mass, such as, for example, hydro and air power generation. In the past, harvesting energy from a moving mass was assumed to be the conventional method for dividing a moving mass in parts in order to add or collect energy from the moving mass. Later, vanes, screws, paddles, impellers, propellers, runners and so forth were developed as devices for slicing a moving mass in order to change its kinetic/mechanical mass potential. The technological challenge illustrated by embodiments herein is to affect the moving mass by adding or removing kinetic/mechanical energy without disturbing flow connectivity.

FIG. 1 illustrates a sectional view of a system 100, in which a dynamic model of mass potential assesses the problem of pumping mass as well as harvesting energy from a moving mass with a symmetric opposite functioning. A zone of lower energy and a zone of higher energy potential can be implemented as mass moves throughout a contained tube 104. The direction of the moving mass can be reversible, as well as, the amount of potential energy exchanged can be additive or subtractive. The dynamic model of system 100 depicted in FIG. 1 illustrates the basic challenge involved in the process of exchanging energy between inertial and rotating forces not addressed yet accordingly on the symmetry of its basic principles. As depicted in FIG. 1, mass 105 can moves within a containment tube 104 inside a zone 102 of lower pressure, or higher suction. Such a configuration can receives a particular amount of kinetic/mechanical energy as it moves toward a zone 103 of higher pressure, or lower suction, thereby attaining a higher level of energy potential.

In FIG. 1, movement from zone 102 toward zone 103 is generally indicated by arrow 107. A subtle physical boundary 101 exists when the kinetic/mechanical energy potential changes 106 between zones 102 and 103 in response to an energy increase by external forces. A special zone for energy exchange between inertial forces and rotating forces comprised can also be formed by zones 108 and 109 as indicated in FIG. 1. Zones 108 and 109 are very sensitive to molecular connectivity due to the propagation effect of mass potential.

Such zones can be provided with an input of kinetic/mechanic energy, which results in an interactive effect that spreads thoroughly backward at zone 108, thereby rearranging molecules for suction or pulling, and forward at zone 109, thereby squeezing molecules for pressure or pushing, in the general direction indicated by arrow 107. Any process involving slicing the mass flow has a high potential to spoil functioning harmony in the energy conversion between inertial and rotating forces. The spoilage of such rendering processes can result in energy losses, a hissing noise, gas formation and so forth.

FIG. 2 illustrates a dynamic model 200 illustrative of molecular connectivity of a fluid moving as unsaturated hydraulic flow and depicting a prevailing directional force upon a hanging porous system (e.g., drying paper). Water 203 can be located with a deposit 202. Water 203 is subject to gravity conditions, and/or saturated zone 103. The water 203 can move upward throughout a porous system 201. The fluid or water 203 moves under the attraction of solid porosity by unsaturated flow indicated by zone 102. A physical boundary 101 exists when water 203 begins to move as a resolute of suction based the adhesion-cohesion (i.e., see zone 102) in the fluid connectivity toward the attraction of the porous system 201.

In the simple configuration of FIG. 2, fluid connectivity in association with the random porosity of a drying paper, can result in the movement of water 203 upward approximately 11.5 cm on a main vertical axis 204, which is approximately twice the distance 5.8 cm of a horizontal axis 205, indicating a partial reference section of vertical and horizontal translocation of prevailing directional forces. This is an important phenomenon regarding the arrangement of molecules (i.e., translocation) following the prevailing vector force of gravity balanced in a less extent laterally by the multidirectional attraction of unsaturated hydraulic flow.

The molecular arrangement of long chains can be represented by single units connected to one another. Consequently, the fluid connectivity supports a longer connection in the prevailing vector direction, in this case upward as indicated by arrow 204. Then, mass flowing inside a containment tube would have a prevailing longitudinal connectivity as depicted by arrow 204 to be considered in the energy exchange approaches. Such a demonstration represents an important insight, which suggests and supports non-partitioning mass flow thereby preserving longitudinal molecular connectivity as depicted by arrow 204 on general mass flow movement. Mass flowing in bulky conditions still preserves high level of molecular connectivity (i.e., water 203), which can vary according to the characteristics of each particular kind. Molecular connectivity is even more evident when gauging water velocity in several sections of a running river. Water moves slowly near the shore and fast in the center.

FIG. 3 Illustrates a cross-sectional view of a containment tube 302 of a system 300, which represents a dynamic model of molecular connectivity with saturated hydraulic flow reducing flow velocity outwardly inside a tube containment associated to the stationary walls. The hydrodynamic model of system 300 includes fluid 301 that runs within a tube 302. As the fluid 301 moves within tube 302, and the center of core 304 experiences a higher velocity, while the outer layers near the walls of tube 303 is dragged slowly, as represented by arrows 303 and 304. Such a scenario is a consequence of molecular connectivity inside the moving mass flow, which displays a strong dragging effect. Preserving this connectivity is very important when exchanging energy between inertial and rotating forces by non-partitioning mass flow movement. Consequently the opposite holds true if the tube wall is not stationary and possesses a high inertial velocity. The mass moving within increases the dragging effect and mechanic/kinetic energy can be transferred to the mass.

The masstubarc flow siphon disclosed herein can be defined as an enhanced geometric interface contention, mostly as a tube-like structure, connecting moving masses continuously in two important segments. Such segments generally include a straight line for the inertial force section and an arc segment for the rotating force section. Energy can be exchanged reversibly between moving masses and rotating devices at a high efficiency level as a consequence of non-partitioning mass flow and an appropriate symmetric geometry that provides smooth energy transfer reversibly, which can be attained with high efficiency by maintaining molecular connectivity in the moving mass.

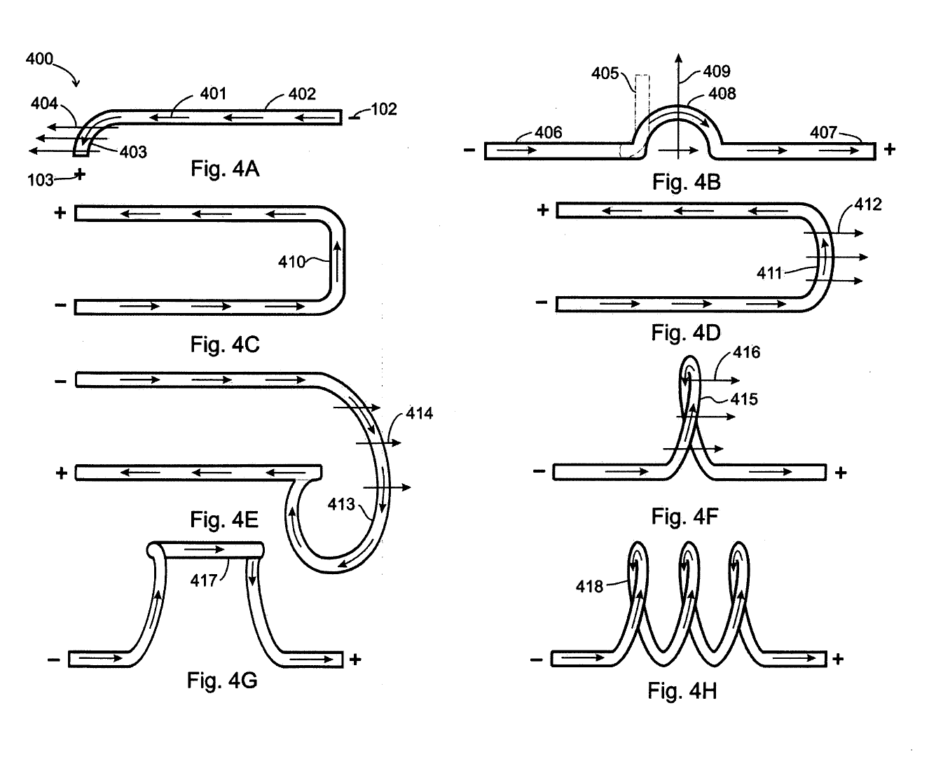

FIG. 4A illustrates a cross-sectional view of a dynamic geometric modeling application of an unbalanced masstubarc flow siphon. Exchanging energy between inertial force and rotating force by a non-partitioning mass flow is analogous for example, to the situation in which a skier moves down a hill. . . . Each turn that the skier makes can be described as an arc that opens longitudinally toward the main path. Such a situation involves a simple process of reducing the downhill energy by slowing the velocity transferring portion of the inertial energy to the arcs through the ski blades splashing snow outwardly. The process of skiing results higher pressures at the inner side of the ski blades at the left foot in order to move the skier toward right. In this case, energy from an inertial force is exchanged to an unbalanced rotating force.

The final stop of a skier 400 can thus be described by FIG. 4A as the main course 402 of a line 401 of the inertial force, while an abrupt turn 403 represents the arc of the rotating unbalanced force 404. The potential energy 102 is reduced to a lower level 103 in this irreversible process of energy exchange for the skier. This process is simply irreversible because the scattered snow cannot return to its original position. This process is reversible to flowing masses and the arc structure 403 can have many special formats. The masstubarc flow siphon 402 is unbalanced because it misses another unit to make a pair and balance the distribution of rotating energy 404.

When a skier hits a tree by mistake, all inertial energy 404 is delivered instantaneously, resulting in bodily injuries as a consequence of localized concentrated inertial energy 404 delivered at very high intensity to specific places on or in the human body. The arc and straight segments are in perfect harmony for the exchange of energy 404, thereby providing a smooth and tangential approach (i.e., see structure 403) for such a transference. Such a scenario is also analogous to automobiles and for preventing frontal collision when driving.

The aerodynamic process of flying also represents a type of energy transfer between inertial and rotating forces. A gliding device or flying animal collects inertial energy from a fast wind and converts it to an upward lift required for staying afloat. The energy for lifting can therefore be supplied by the moving mass of air in the gliding process when the wings of the bird or gliding device are held still.

FIG. 4B illustrates a cross-sectional view of a dynamic geometric modeling application of a reversible unbalanced masstubarc flow siphon to exchange energy between inertial and rotating forces by non-partitioning mass flow. The system depicted in FIG. 4B becomes reversible, because mass moving from one leg of a siphon 406 to the other end 407 thereof can have an opposite direction from the end 407 of the siphon to the siphon 406 itself. The moving mass 401 initially changes direction as depicted at portion 405 to enter thereafter into an unbalanced arc rotating movement at arc 408. This lateral pull (i.e., see arrow 409) by the transition of inertial energy to an unbalanced rotating energy can provides a lift for airplanes in the wing format. Also, this lateral traction (i.e., see arrow 409) can be applied to rotating mechanisms that collect energy from a moving mass.

Rotating pumps, particularly centrifugal-based pumps, can take advantage of a masstube siphon because the siphon can provide a strong contention support in the process of adding kinetic/mechanical energy to the moving mass. Most centrifugal pumps may not be required to be flux reversible and therefore can be based on a simpler manufacturing concept. The geometric structure provides an important feature for higher velocities due to the preservation of molecular connectivity.

FIG. 4C illustrates a cross-sectional view of a dynamic geometric modeling of a nonreversible linear masstubarc flow siphon to exchange energy between inertial and rotating forces by non-partitioning mass flow movement. Because the portion or segment 410 functioning within the rotating force is linear, this linear masstubarc flow siphon application is not reversible because changing the rotating direction does not affect the mass flow direction, because tangential work is not present in order to make it reversible, thereby affecting the manner in which centrifugal and centripetal forces are balanced or handled to distribute the extent of acceleration for mass pushing and/or pulling.

The simplest design would permit only the linear segment 410 to rotate, while the remaining segments can be stationary. In this case, the linear segment 410 can be configured in multiple directions on the rotating device to provide a broad dimension for the rotating force application during the process of adding energy to the moving mass. Providing an increasing level of roundness to the straight segment 410 can leads to an arc feature 411 that possesses a different special effect of tangential angles as well as a format,. This can result in positive acceleration when the arc is convex or negative when the arc is concave, both in relation to the rotating direction.

FIG. 4D illustrates a cross-sectional view of a dynamic geometric modeling application of a reversible arc masstubarc flow siphon to exchange energy between inertial and rotating forces by non-partitioning mass flow movement. The mass flow becomes reversible because the arc feature 411 can possess a variable tangential angle in the rotating segment of the masstubarc flow siphon resulting in a smooth energy transfer as indicated by arrows 412. In some circumstances, a uniform tangential force can be applied at the arc of the masstubarc siphon to move mass inward or outward. Uniform tangential force can be applied, as indicated by spiral-like format in such an arc.

FIG. 4E illustrates a cross-sectional view of a dynamic geometric modeling application of a spiral masstubarc flow siphon to exchange energy 414 between inertial and rotating forces by non-partitioning mass flow movement. The mass flow becomes also reversible with the arc feature 413 providing a more uniform tangential angle to move reversibly mass inward or outward depending on the rotating direction. It is mechanically simpler to feed mass to a rotating device close to the center in order to generate a lower torque with respect to a smaller sectional area. A combined outward arc flow and an inward arc flow in a circular configuration can permit mass be transmitted outward. Thereafter, the mass can be transmitted inward, adding or removing energy 416 according to operation design considerations.

FIG. 4F illustrates a cross-sectional view of a dynamic geometric modeling application of a circle masstubarc flow siphon to exchange energy between inertial and rotating forces. The fluid mass will cycle reversibly according to the acceleration angle of a tangent 415 of the circle in the arc section. The mass will move inward or outward depending on the rotating direction and the curved shape of arc 415. Because one of two straight segments of the masstubarc siphon running the inertial forces are located closer to the rotating center, while other segment is located closer to the outer boundary, a differential force effect results because of the variable radius length connected by the rotating arc. A longer length toward the straight leg of the masstube siphon located in the outer boundary permits a longer time for the moving mass to be affected by the rotating power of the rotating device.

FIG. 4G illustrates a cross-sectional view of a dynamic geometric modeling application of a reversible masstubarc flow siphon in a circle with a booster configuration to exchange energy between inertial and rotating forces by non-partitioning mass flow movement. A masstubarc flow segment 417 can add a delay to the mass moving at the curved surface, thereby providing additional time for the mass to acquire a larger level of rotating energy during the exchange process, because the booster configuration is located near a rotating outer border. Because the mass is not partitioned, a combination of multiple circles can provide an extended feature for exchanging energy between rotating forces and inertial forces via a reversible masstube siphon. A spring configuration for a masstube siphon is important for high speed rotation when a longer interface is required to affect the moving mass more effectively.

FIG. 4H illustrates a cross-sectional view of a dynamic geometric modeling application of a spring masstubarc flow siphon to exchange energy between inertial and rotating forces by non-partitioning mass flow movement. A spring 418 is composed of multiples continuous circles 415 providing additive rotating affect for the energy exchange to the moving mass in the arc segment.

Combining a pair of opposed masstubarc siphons to a rotating device as a balanced arrangement provides a special feature for adding kinetic and/or mechanical energy to a moving mass by non-partitioning flow. In this case, mass flowing throughout a masstubarc siphon can interchange its energy level with rotating forces when moving between two straight tube segments which are connected by another straight tube segment pointing outward due to rotating motion. Due to the special containment molecular connectivity in the mass, flow can be.

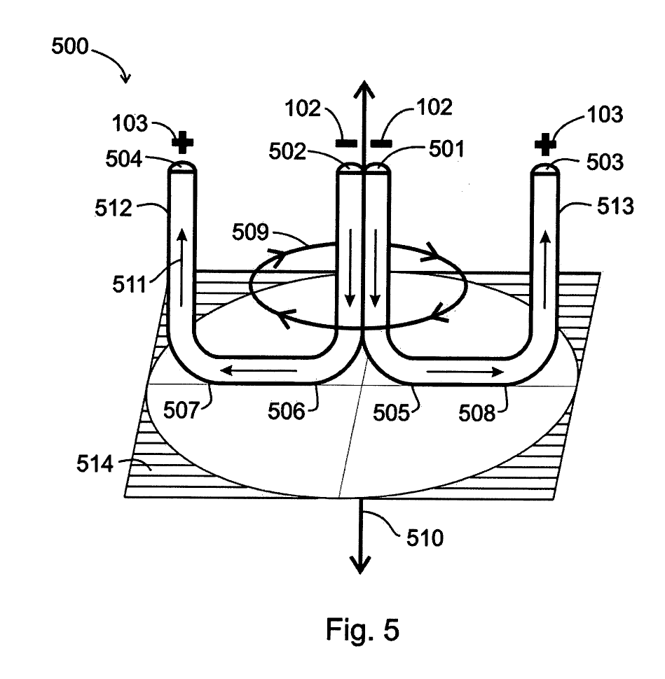

FIG. 5 illustrates a cross-sectional view of a system 500, including spatial modeling of a nonreversible and linear masstubarc flow siphon that can exchange energy between inertial and rotating forces by non-partitioning flow movement. Two opposite linear masstubarc siphons 512 and 513 can be assembled radially to an imaginary rotating device 514 that rotates or turns clockwise. The masstubarc flow siphon moves mass 511 from sections 501 and 502 to sections 503 and 504, respectfully, by a rotating force represented by circular arrow 509 about an axis 510.

As the mass reaches the points 505 and 506, the rotating energy is added by rotating forces throwing the mass outward of the circle at points 507 and 508, thereby increasing the kinetic/mechanical energy of the moving mass from lower mass potential level 102 to higher level 103. Altering the rotation direction 509 does not affect the mass flow direction represented by arrow 511, thereby making the linear masstubarc flow siphon of system 500 not reversible because there is no tangential angle working at the rotating tube segment to provide differential effect of rotating forces in order to make the mass move inward or outward the rotating wheel. Also, energy from the moving mass cannot be collected reversibly back by the rotating device because the rotating segment does not have an arc format or arc configuration. The linear masstubarc flow siphon of system 500 can be simple to manufacture and to use for pumping operations requiring a unique mass flow direction.

Adding curvature roundness to the straight masstubarc siphon tube segment 410 that move masses in the rotating device can affect the level of energy added and/or removed. If the curvature is convex toward the rotating direction, it will increase the amount of energy added because the path in the tube outward becomes longer compared to the radial straight path. If, however, the roundness or curvature is concave toward the rotating direction, it will reduce the amount of energy added to the moving mass because of a shorter path as compared to the radial straight path. The level of energy reduction on the concave format can decrease proportionally to the roundness expansion from a straight path until the flow becomes reversible.

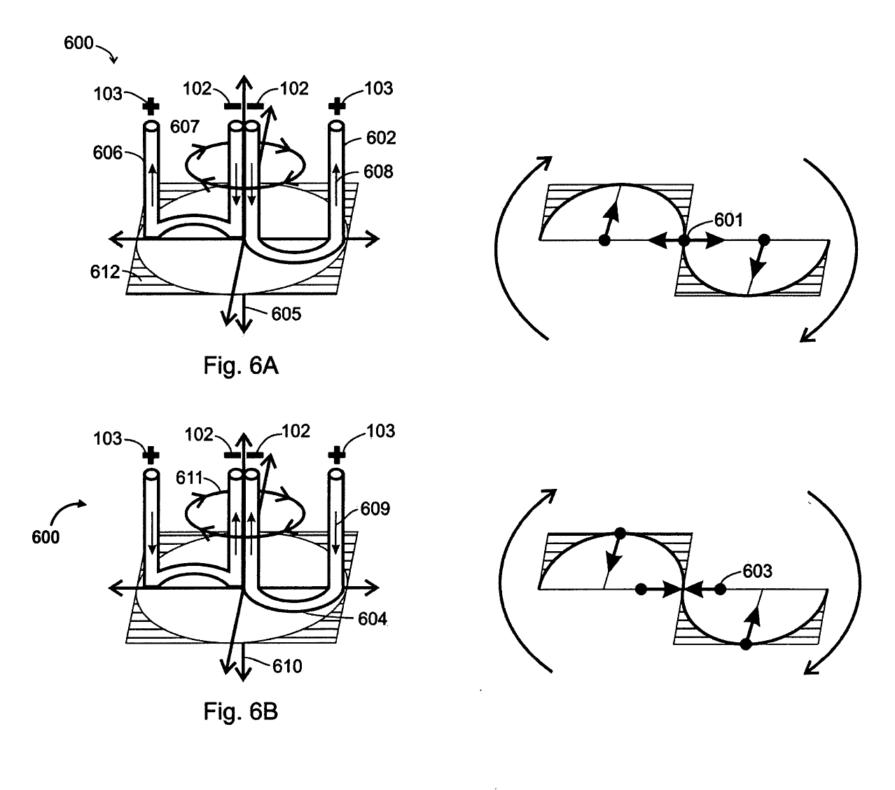

FIG. 6A illustrates a cross-sectional view of a system 600, that includes spatial dynamic modeling application of a reversible and curvilinear masstubarc flow siphon by adding energy, thereby reducing molecular bonding tightness at point 601, and increasing velocity to the mass exchanging energy between inertial and rotating forces by non-partitioning mass flow movement. Two opposite curvilinear masstubarc siphons 602 and 606 can be assembled radially to an imaginary rotating device 612 turning clockwise 607. As a rotating force 607 acts upon a masstubarc flow siphons about an axis 605 thereof, the mass within the tube containment 608 moves from a zone 102 of lower mass matric potential to a zone 103 of higher mass matric potential, thereby receiving kinetic/mechanical energy by the rotating motion and then reducing molecules binding, as indicated by point 601, away from the rotating center by a tangential force applied at point 602. If the rotating direction 607 changes, the flow 608 inside the masstubarc flow siphon may also change reversibly its direction, depending upon the roundness or curvature level of the arc balancing inward and outward forces.

By way of analogy to skiing, when a skier moves downhill from a straight path, making a slight lateral turn in arc, the velocity of the skier can be reduced as kinetic/mechanical energy is transferred smoothly to the cutting edge of ski blades. The same approach can be applied to a moving mass delivering its energy when moving throughout an arc section of a containment.

FIG. 6B illustrates a cross-sectional view of system 600, including a spatial dynamic modeling application of a reversible and curvilinear masstubarc flow siphon by harvesting energy, wherein colliding molecules increase binding tightness at indicated at point 603, and decrease velocity to the mass, thereby exchanging energy between inertial forces of the mass to the rotating forces of the masstubarc flow siphon by non-partitioning flow movement.

System 600 of FIGS. 6A and 6B generally illustrates a masstubarc flow siphon. The mass 609 moving inside the reversible masstubarc flow siphon bears a higher level of kinetic/mechanical energy 103, which delivers rotating energy at an arc section 604 to promote a reduction of speed, while forcing the molecules closer to each other at the rotating center 603, which permits masstubarc flow siphon to possess a lower level of kinetic/mechanical energy 102. The energy harvested from the moving mass 609 can be transformed from inertial energy to rotating energy 611 about the axis 610. If the mass flow direction 609 changes inside the masstubarc flow siphon, the rotation direction does not change because each masstubarc flow siphon pair possesses an opposed unbalance with unique vectoral rotating directions within the arc section 604. If the mass flow direction 609 changes inside the masstubarc flow siphon, the rotation direction can also change if a reversible circle masstubarc flow siphon such as that depicted in FIG. 4F is employed.

A circular set of convex and concave rounding segments for a masstubarc siphon can provide interesting insights into outward and inward flow affected by centrifugal and centripetal forces for the rotating motion. Because the rotating force is defined as a product of mass by the squared velocity divided by the radius (f=m.v²/r), then outward and inward flow is dependent on the path compared to the radius magnitude.

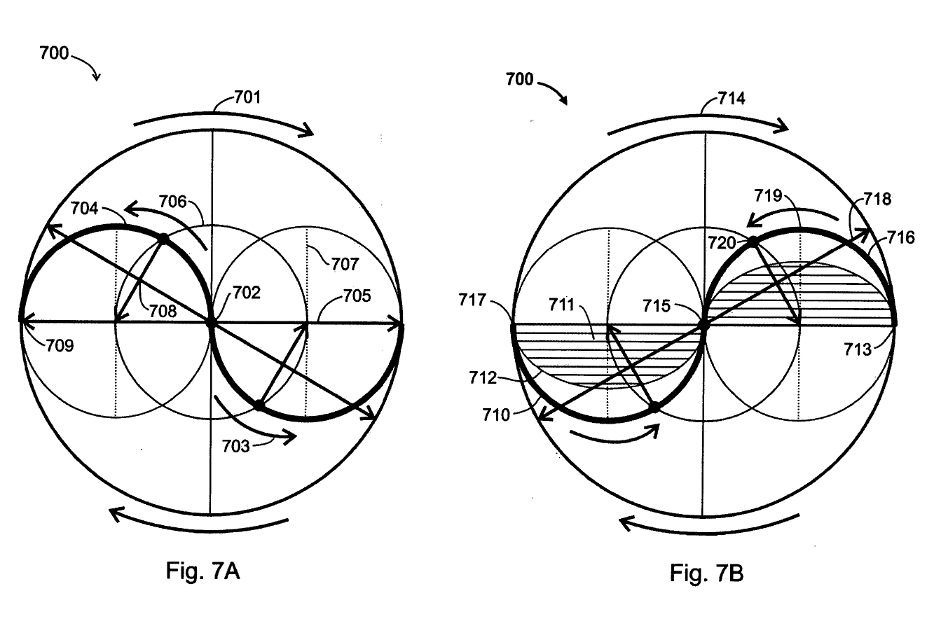

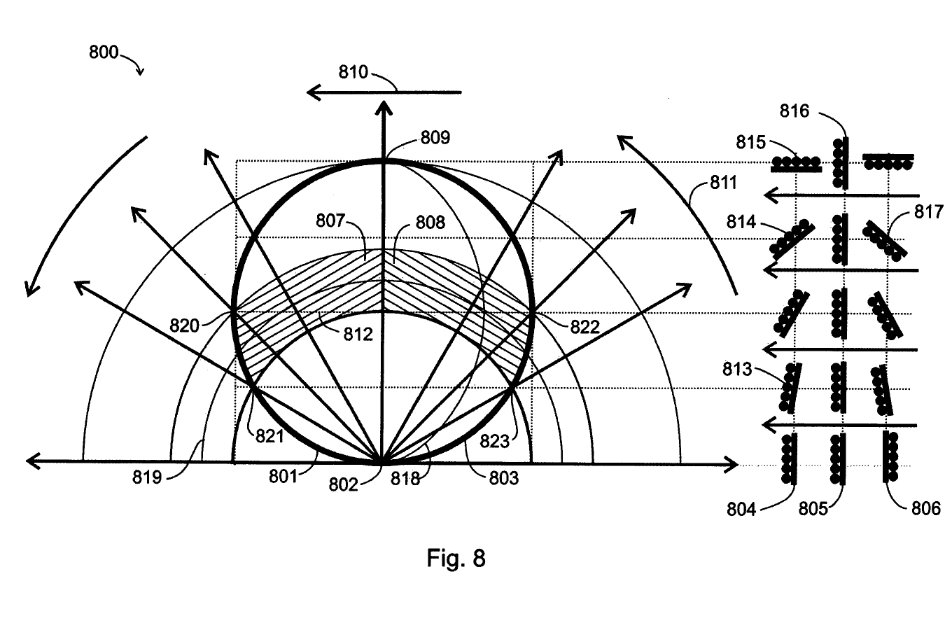

FIG. 7A illustrate a cross-sectional view of a system 700 that includes the spatial dynamic geometry of a pair of reversible and curvilinear masstubarc flow siphon 704 assembled to a rotating device as outward flow to exchange energy between inertial and rotating forces by non-partitioning flow movement. Mass flow at the center 702 moves outward at indicated by arrow 703 when the rotation of the masstubarc flow siphon 704 turns clockwise as indicated by arrow 701. This situation occurs when the reversible masstubarc siphon 704 in circular rotation changes its center as depicted at circle 706 from the main course 707. Such a scenario can provide for a stronger push outward because the arc is located in an accelerating position associated with the rotating center 702 and outer exit 709 as referred by the axis 705.

FIG. 7B illustrates a cross-sectional view of a system 700, including spatial dynamic geometry of a pair of reversible and curvilinear masstubarc flow siphon assembled to a rotating device as inward flow to exchange energy between inertial and rotating forces by non-partitioning flow movement. When the rotating direction 714 is the same as depicted in FIG. 7A and the masstubarc flow siphon 704 is located point opposite 716 having an acceleration arc delay from points 713 to 715, the mass moves inward. When the masstubarc flow siphon 704 forms a straight line from the center 715 to the outer boundaries 713 and 717, the mass can move outward in any rotating direction. As the arcs 710 and 719 increase roundness or curvature from the straight line 705, the tangential angle alters the balance between centrifugal and centripetal forces, thereby decreasing the acceleration force and reversing the mass flow from an outward direction to an inward direction.

The shaded area 711 represents the boundary for such an acceleration, with an increasing curvature of the masstubarc flow siphon 704 from irreversible flow to reversible flow 712 when the tangential angle and the bisector angle 708 and 718 is approximately 30 degrees. Then, it can be stated that there exists a neutral zone or neutral shape 712 where mass flow is motionless. The neutral shape is not unique because it can trade curvature with different torques and is radius-size dependent. Gently increasing the convex curvature of line 705 can provide a faster push by the tangential angle, thereby offering a variable degree of conversion between rotating forces to inertial forces in order to attend several mass transport requirements. The reversible line may be acceleration dependent and include optional formats for trading centrifugal and centripetal forces.

The neutral zone 711, or neutral shape 712, possesses a special geometric form of shallow concave masstubarc flow siphon, thereby promoting neither inward nor outward flow movement 712, because the sum of all centrifugal and centripetal forces acting entirely on the arc would cancel each other by the delay of the acceleration from points 719 to 720. Such a feature may be important for moving mass inward or outward, while maintaining previous inertial and/or rotating energy potential. Consequently, a moving mass can enter or exit the rotating wheels of the masstubarc flow siphon 704 at the center or border thereof, depending on the mechanical approach taken in order to achieve the best possible performance.

To some extent, adding and/or removing mechanical/kinetic energy to mass flow by non-partitioning does not need to be uniform throughout the reversible masstubarc siphon. Since the moving mass is molecularly connected continuously in a longitudinal section, differential effort exerted can create advantages wherein the total effect results from the summation of all partial effect in each segment through which the mass moves. Simple experiments can be performed to gauge the level of effect that a moving mass can withstand when different gradients of tangential effect add or remove mechanical/kinetic energy. Several levels of “roundness” curvature can be then employed in order to achieve the best dynamic performance goal for the transfer of energy between rotating and inertial forces according to each application.

FIG. 8 illustrates a cross-sectional view of a system 800 that includes tangential geometric modeling of a leg of a reversible masstubarc flow siphon for exchanging energy between inertial and rotating forces by non-partitioning flow movement. The tangential angles are variable and the mass flows outwardly, as can be seen at reference point 804 for the tangential angles, which can move along a path 801 that becomes reversible (as indicated at reference point 806) by a path 803. In a spring-like spiral, the flow is reversible but does not come back to the same original point 802.

Mass flowing outward from point 802 would possess a nonreversible direction toward point 809, if the siphon is straight as depicted at reference point 805, thereby maintaining a constant zero tangential angle 816 in the direction the rotation takes, which is indicated by arrow 811. The flow, however, would move faster outwardly in a rounded path toward acceleration 801 because the rotating force altering the main vectoral motion 812 to a curved motion can displace the core center 30 degrees inward with a positive acceleration 807 and a negative acceleration 808 as result of the inertial force 810 moving in circular path. Another simple conceptual model involves the fact that the path 801 is longer than the straight line from 802 to 809, requiring more energy for the mass flow to overcome a longer distance according to the rotating direction indicated by arrow 810.

Because the inertial center of the moving part 820 is dislocated toward a constant rotating center 821, a higher exertion of the favorable angle in an outward direction (as indicated by reference point 814) and a reduced exertion of reference point 813. Reference point 815 is neutral and parallel to the motion indicated by arrow 810. Mass flow moves in as inward direction from point 809 to point 802 with the acceleration acting on the tangential force as shown at point 808 and reference point 806. The tangential forces acting at point 803 can be observed at point 806 as the tangential angle changes during a full path thereof. Due to the dislocation inward of the motion center from points 822 to 823, an increased push at the angle 817 can be observed. The full length of arc 803 is longer than the straight line from points 802 to 809 plus the centripetal displacement from points 822 to 823, thereby forcing the flow inward. The path 818 as tied to point 819 suggests a possible boundary between reversibility.

One of the simplest applications of a masstubarc siphon for pumping operations requiring no reversible flow involves utilizing a straight tube containment in the rotating device, wherein such a containment is assembled radially. The manufacturing process for such a configuration can be very simple. For example, a wheel with asymmetric perforated tubes configured in a radial direction toward the influx center may be utilized. A unique pump for a heavy work load may possess multiple wheels in order to increase its capacity for converting rotating energy to inertial energy. Since there is no partitioning in the flow mass movement, increasing the pump speed may provide a linear effect on its performance, depending on the bulky molecular connectivity necessary to transmit suction toward the source of the fluid for continuous flow input under a steady workload.

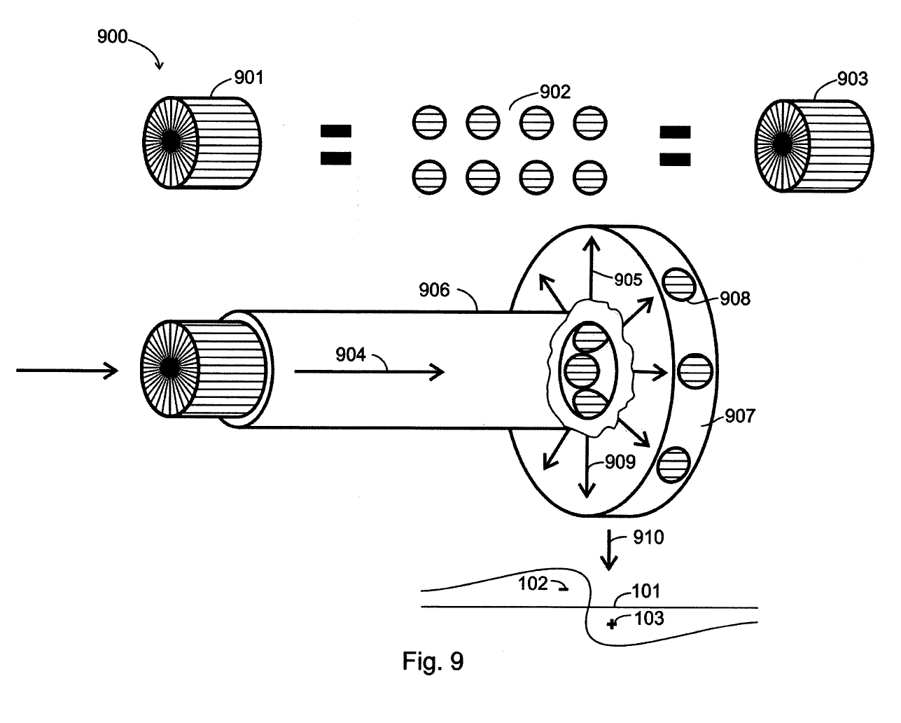

FIG. 9 illustrates a lateral view of a simple molecular rotating pump core functioning system 900 and mass balance dynamics that includes a nonreversible masstubarc flow siphon and non-partitioning flow movement thereof. Most applications of masstubarc flow siphons can function as a simple relation of equality of the input 901, rotating working mass 902, and output 903. The mass input flows inward as indicated at arrow 904 inside the straight segment of masstubarc siphon 906, and then turns laterally as indicated by arrows 905 and 909 within pairs of masstubarc flow siphons 908 within a rotating wheel 907, and finally exits the pump system 900 as indicated by arrow 910. A simple molecular rotating pump can therefore include multiple masstubarc flow siphons 908 and multiple wheels 907 to attend any mass flow requirement. The fluid can exit the pump by a routing the wheel for outward flow. The outlet can be aligned to the same input direction 904 or optionally opposite to it. Mass influx gains energy 103 at the rotating wheel affecting a subtle potential mass boundary 101 from previous level 102.

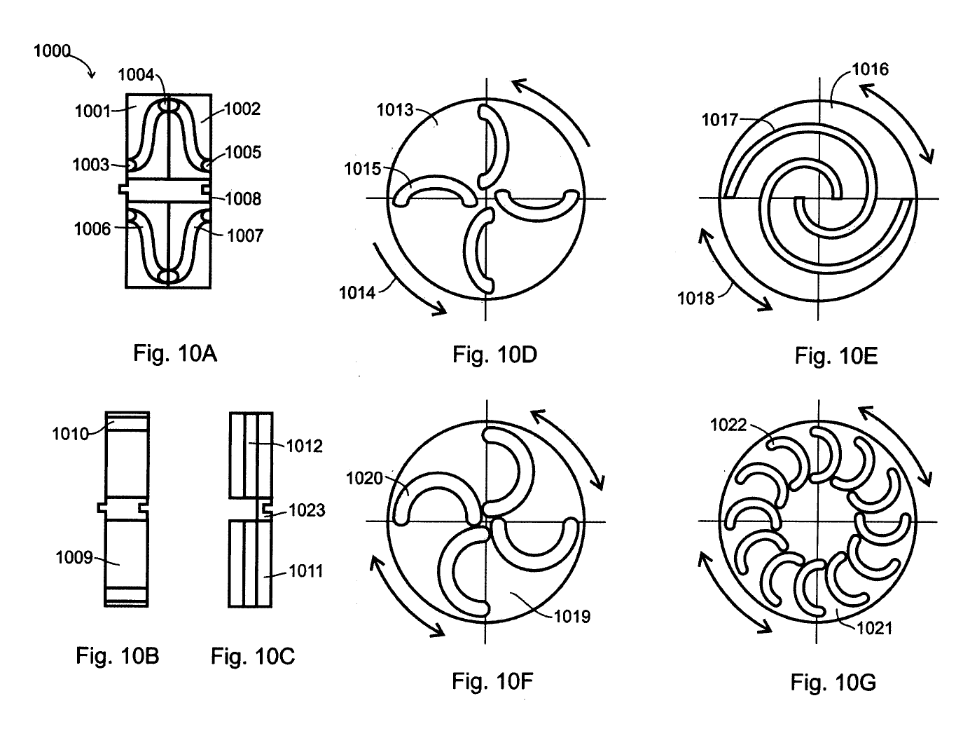

The reversible masstubarc can be contained entirely within one or many modules as a rotating device offering an expanding interface for energy exchange between rotating and inertial forces. The rotating part of the masstubarc siphon can be employed in many situations, including parallel and/or serial arrangements, thereby taking the moving mass outward and/or inward. Such configurations can provide features for combining modules using many rounding formats in the mass contention for a varied approach. FIG. 10A illustrates a cross-sectional longitudinal view of a spatial modeling application of a multiple parallel masstubarc flow siphon in a double wheel serial module to exchange energy between inertial and rotating forces by non-partitioning flow movement.

The first wheel 1001 can send the mass flow outward from 1003 to 1004, while the second wheel 1002 receive the mass flow from 1004 and send it inward to 1005. The two wheels rotates around an axis 1008 and the masstubarc flow siphon 1006 is designed to send masses outwardly while the masstubarc flow siphon 1007 is designed to send masses inwardly back toward the center converting the rotating forces to inertial force closer to the rotating center. The combination of masstubarc siphons 1006 and 1007 comprises one rotation of a circle of a spring-like feature. Consequently, additional pairs of wheels 1001 and 1002 can add more rotation units in a spring-like configuration to the moving mass, thereby increasing the performance of energy exchange between rotating and inertial forces.

Situations may arise in which the moving is required to remain longer at the outer boundary of the wheel in order to implement a longer lagging time for energy exchange thereof. Situations may also arise in which the moving mass is needed closer to the center thereof in order to reduce the extent of the rotating force for conversion to an inertial force. A simple wheel with a straight segment of masstubarc siphon can provides such options.

FIG. 10B illustrates a cross-sectional longitudinal view of a spatial modeling application of a high velocity booster to exchange energy between inertial and rotating forces by non-partitioning flow movement. The wheel 1009 can have a segment 1010 of a masstubarc flow siphon linearly parallel to the rotating axis 1008 rotating at high velocity near the outer border or low velocity close to the center. These wheel booster 1009 would provide a longer lagging time for masses to exchange energy between rotating and inertial forces at low or high velocity of the rotating device. Many applications of pumping operation like in FIG. 9 may not require flow reversibility and a straight masstubarc siphon would allow an easier manufacturing simply by puncturing pairs of void cylinders to a rotating wheel. Such rotating pumps also can use multiple rotating wheels.

FIG. 10C illustrates a cross-sectional longitudinal view of a spatial modeling application of a linear non-reversible masstubarc flow siphon to exchange energy between inertial and rotating forces by non-partitioning flow movement. The rotating wheel 1011 rotating around an axis 1023 contains straight radial pairs of masstubarc siphons 1012 providing containment to the mass flow receiving kinetic/mechanical energy during the rotating process. The diameter of the wheel 1011 and the dimensions and number of masstubarc siphons 1012 should be set in accordance to each application requirement. The masstubarc siphons 1012 can have a uniform longitudinal dimension to provide a steady mass contention, or it might be advantageous in some cases to have increasing diameter inward or outward, providing a special effect for molecular connectivity and energy transfer between inertial and rotating forces. This progressive change in the masstubarc siphon diameter can also compensate for expansion or contraction of mass flow being affected by energy exchange.

FIG. 10D illustrates a cross-sectional view of a spatial modeling application of a multiple parallel masstubarc flow siphon as neutral force design wheel for counterclockwise direction to exchange energy between inertial and rotating forces by non-partitioning flow movement. The wheel 1013 rotating counterclockwise 1014 has pairs of masstubarc flow siphons 1015 that at a certain acceleration which may vary represents the boundary between irreversible and reversible flow by the modulation of the concave roundness or curvature of the masstubarc flow, thereby making the mass move inward or outward.

Because the tangential angle is not unique and the speed increase away from the center, the neutral force might have this concave neutral format some variation in order to attain a neutral force pushing inwardly and outwardly. Irreversible flow happens when the masstubarc flow siphon is a straight line and in any rotating direction the mass will always flow outwardly. Adding a curvature or concave roundness to the masstubarc flow siphon toward the rotating direction, and changing the tangential angles, and delaying the acceleration, can result in reversibility when the mass flow rotates in one direction. It seems that the path length of a neutral masstubarc flow siphon is equal to the radius plus the diameter thereof times pi/6 (i.e., for one side only), or the radius plus the diameter thereof times pi/3 for both sides. If two sides are considered, advance and delay acceleration displacement can occur inwardly for approximately 30 degrees.

Some mass moving throughout the rounded reversible masstubarc siphon might benefit from a constant tangential angle. FIG. 10E illustrates a cross-sectional view of a dynamic spatial modeling application of a multiple parallel reversible and curvilinear masstubarc flow siphon in spiral to exchange energy between inertial and rotating forces by non-partitioning flow movement. The wheel 1016 has masstubarc flow siphons 1017 at spiral format with uniform or exponential tangential angles at varying degrees making the siphon reversible 1018 inward/outward with several levels of energy exchanging accounting by the length of the spiral form the center to the outer boundary and vice-versa.

The amount of masstubarc siphon units, its diameter, and its length affect the level of energy exchange as a certain amount of mass moves through the rotating device. FIG. 10F illustrates a cross-sectional view of a dynamic spatial modeling application of a multiple parallel and reversible masstubarc flow siphon in two opposite pairs to exchange energy between inertial and rotating forces. The wheel 1019 rotating clockwise to send the mass flow outwardly by the masstubarc flow siphons 1020 or rotating counterclockwise to send the mass flow inwardly.

FIG. 10G illustrates a cross-sectional view of a dynamic spatial modeling application of a multiple parallel and reversible masstubarc flow siphon in six pairs to exchange energy between inertial and rotating forces. Larger number of reversible masstubarc flow siphons 1022 would allow the wheel 1021 work on a larger volume of masses and releasing a larger torque for operating farther from the rotating center.

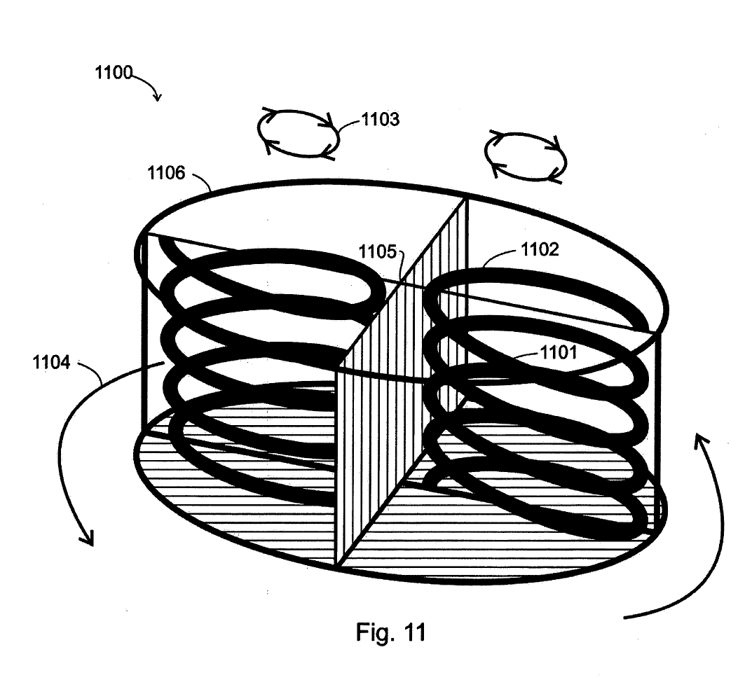

The process of energy conversion between rotating forces and inertial forces by non-partitioned flow movement may require a more extensive interface in the rotating device, depending upon the characteristic of each mass employed, mainly those with a lower density. A longer interface in the rotating device can be attained by assembling serial pairs of outward and inward masstubarc siphons, or combined circles in a spring-like assembly or configuration. FIG. 11 illustrates a lateral view of a dynamic spatial modeling application of a multiple serial reversible masstubarc flow siphon in a spring-like assembly to exchange energy between inertial and rotating forces by non-partitioning flow movement.

The masstubarc flow siphons are continuous having 1101 with inward effect and 1102 outward effect when the rotating wheel 1106 is running counterclockwise 1104 in the center 1105 making the masstubarc flow move in opposite direction 1103. The masstubarc flow siphons 1101 and 1102 in a serial assembling have combined effect which would let the rotating force distribute uniformly compensating the differential tangential push as the bulk flow has non-partitioning movement. The format of a serial combination of 1101 and 1102 is similar to a spring; however it can be deformed to other formats if spiral-like format is attempted, increasing the effect of 1102 outward and/or 1101 inward. The length of the spring-like format of the masstubarc flow siphon in serial combination is dependent on each application according to the characteristics of the masses moving throughout it, as well as with the energy exchange performance and its reversibility.

By way of analogy or reference to a running river, a stationary river bank can hold the rapids in an increasing level, away from the center toward the shore. Thus, a fast moving contention boundary can transmit its motion energy gradually to the mass it contains. The rate of energy exchange between the inertial mass and the rotating device depends on the mass physical properties and the geometry of the exchanging interface as well as its working performance.

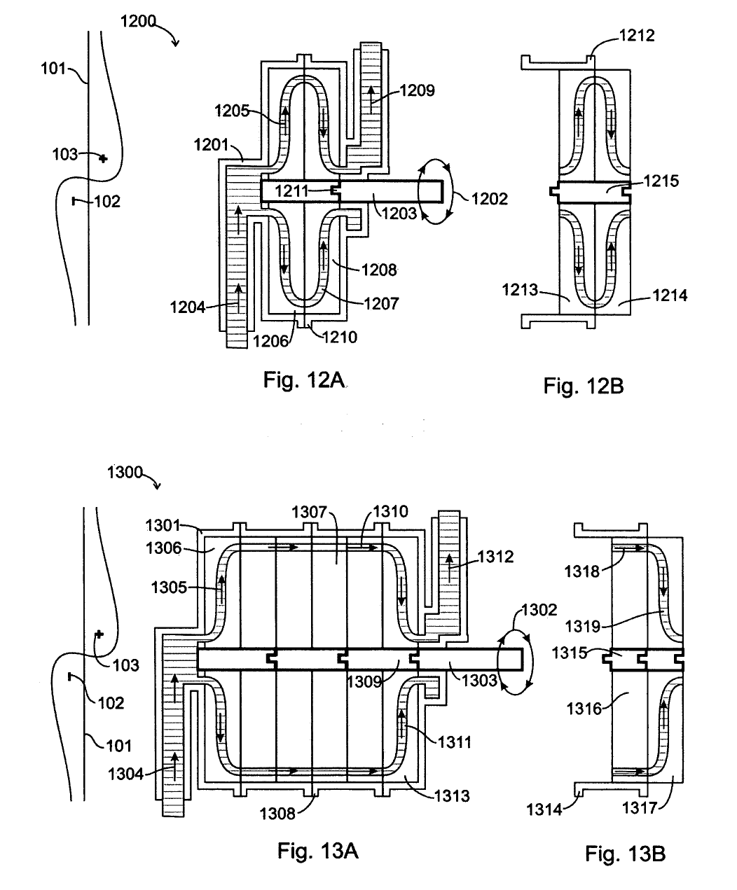

FIG. 12A illustrates a cross-sectional horizontal view of a spatial modeling of a reversible molecular rotating pump with masstubarc flow siphon by non-partitioning flow movement. Mass flowing throughout the molecular rotating pump 1200 creates a boundary of pressure 101 when it pulls the mass by suction 102 and push it forward 103. The molecular rotating pump 1201 can be configured about a rotating axis 1203 (i.e., see circular arrow 1202) with double wheels 1206 and 1208 in a serial masstubarc flow siphons that pull the mass inward as indicated by arrow 1204. The first wheel 1206 moves the mass 1205 outwardly and sequentially the second wheel 1208 moves the mass inwardly 1207 as inertial force delivery afterwards. The mass leaves the molecular pump at 1209. The molecular rotating pump can receive additional modules by the outer case join at 1210 and the axis at 1211. A flexible assembling approach might be very important to fit to any expected variable demand of workload. Easily the molecular pump 1201 can be opened and expanding modules can be added or removed.

FIG. 12B illustrates a cross-sectional horizontal view of a spatial modeling of optional adding pumping modules to a reversible molecular rotating pump masstubarc flow siphon by non-partitioning flow movement. The outer case adding module 1212 is combined to the wheel pairs 1213 of outward flow and 1214 of inward flow rotating around the 1215 adding axis. Many pairs of pumping modules with varied characteristics can be implemented in association with a pump to alter its hydraulic performance to a variable demand.

Because the perimeter length is a product of the diameter times pi, for each unit increased in the diameter, the perimeter also increases 3.14 times thereof. Force, however, is the ratio of mass times the squared velocity divided by the radius, being directly proportional. An advantage of the energy exchange process described herein involves the exploitation of higher torque effects away from the rotating center.

FIG. 13A illustrates a cross-sectional horizontal view of a dynamic modeling application of a reversible molecular rotating booster pump with reversible masstubarc flow siphon by non-partitioning flow movement. The mass passing through the pump receives additional kinetic/mechanical energy in the rotating motion as the energetic potential modeling shows a reduction 102 and an increase 103 having a transition boundary 101 under effect.

The rotating booster pump 1301 has a rotating axis 1303 which rotates reversibly 1302 pulling the mass 1304 by the first wheel 1306 which is designed to promote outward flow by the 1305 reversible masstubarc flow siphon. This booster pump has additional booster modules 1307 which are added according to the outer case 1308 offering a lag time of high speed in the outer rotating wheels and delivering higher mass velocity 1310. Additional axis 1309 is part of the expanding option. The last rotating wheel 1313 has an inward reversible masstubarc flow siphon 1311 to bring the moving mass toward the rotating center 1303 for inertial motion. The mass exits the pump at 1312.

FIG. 13B illustrates a cross-sectional horizontal view of a dynamic modeling of optional adding pumping modules to a reversible molecular rotating booster pump with reversible masstubarc flow siphon by non-partitioning flow movement. Additional options of pumping modules have an outer case component 1314, optional extending rotating axis 1315 and booster rotating wheels 1316 to increase lag time for energy exchange in the rotating device 1318 masstubarc contention. Optionally, the booster rotating wheels 1307 and 1316 can be configured with an outer curved masstubarc siphon segment to form a sort of vane or screw effect with clockwise or counterclockwise advancements thereof, which can offer another arc effect in the perimeter for energy exchange between inertial and rotating forces. The rotating wheel 1317 can possess inward or outward 1319 flow direction to bring the moving mass close to the center 1303 in the middle section or in the booster pump exit.

The conception of molecular filtering of fluids, or mass, by molecular connectivity regards the application approach of dragging a long chain of molecules passing throughout an enhanced geometric porosity which provides a variable level of sieving and unsaturated hydraulic flow with a special longwise anisotropy. The effect of solid porosity attraction plus molecular connectivity can be also improved by a very fast flow of non-partitioning movement potentially delivering a huge load for filtering work.

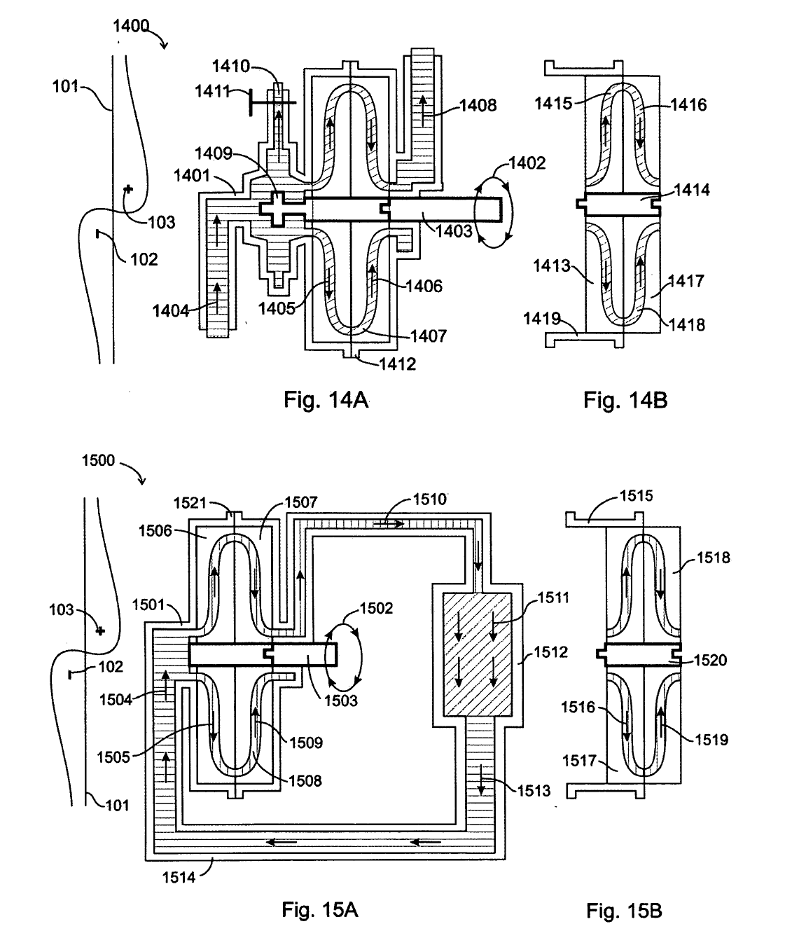

FIG. 14A illustrates a cross-sectional horizontal view of an enhanced dynamic modeling application to reversible fluid filtering system using molecular rotating pump with masstubarc flow siphon and unsaturated hydraulic siphon by non-partitioning flow movement. The reversible fluid filtering pump 1401 pulls fluid 102 and push it 103 passing through a differential zone 101 during the filtering process. The rotating axis 1403 has a rotating direction 1402 which can be reversible for cleaning operation. Fluid enters the pump 1404 and as fluid is filtered through the unsaturated hydraulic siphon (i.e., see U.S. Patent Publication No. US 2003/0160844 A1) 1407 at the direction 1405 as outward flow and direction 1406 as inward flow by the rotating wheels.

To prevent clogging or the accumulation of sediment, the reversible rotating appendix propeller or vane 1409 can create a cycling motion that “pushes” sediment toward the zone or point 1410 under a controlled output 1411. Filtered fluid exits the pump at as indicated by arrow 1408 while impurities exit the pump at the zone or point 1410 under a continuous or intermittent operation. An expanding module can be added at location 1412. The filtering unsaturated hydraulic siphon 1407 can have many filtering capabilities to attend a varied range of specific requirements. The cleaning operation to remove impurities retained in the filtering process can be a continuous option if the amount of sediment is sufficient to keep the operation running. Otherwise, an intermittent option with possible reversible flow can be scheduled automatically or manually, for each specific task employed in the filtering operation.

Molecular filtering utilizing a masstubarc for rapid fluid or mass flow together with an unsaturated hydraulic siphon represents a significant enhancement over current alternatives, because molecular filtering provides a much larger filtering surface and enhanced mass flow by non-partitioning movement. Such a method can be derived from molecular filtering conceptions in which impurities are not retained. Fluid or mass can be removed by molecular connections thereof. Mass filtering such as that found in vacuum cleaners also can utilize the core approach described herein with respect to particular embodiments. Thus, the embodiments disclosed herein can offer the potential to remove all particles during a cleaning operation while preventing solid particles from crossing over into the filtering process.

FIG. 14B illustrates a cross-sectional horizontal view of an enhanced dynamic modeling application of optional adding pumping modules to reversible fluid filtering system using molecular rotating pump with masstubarc flow siphon and unsaturated hydraulic siphon by non-partitioning flow movement. The optional adding module allows increasing the pumping and/or filtering performance of the pump. It has an outer expanding case 1419, expanding rotating axis 1414, outward flow wheel 1413 with reversible masstubarc flow siphon 1415 and optional filtering element by unsaturated hydraulic siphon 1418, and to move the fluid toward the center it has a rotating wheel 1417 with a reversible masstubarc flow siphon 1416 and optionally a filtering element 1418. It is possible to use more than one kind of filtering siphons 1407 and 1418 with different and combined properties applied to unique pumping operation.

The process of adding and/or removing kinetic/mechanic energy can be utilizing in the context of a heat exchange system for general cooling operations because a pumping system thereof can provide a smooth compression necessary for cooling gas in a closed system. FIG. 15A illustrates a horizontal cross-sectional view of a dynamic modeling application of a heat exchanging system using a reversible molecular rotating pump with masstubarc flow siphon by non-partitioning flow movement. Heat can be exchanged by a pumping system as a mass of gas 1504 is pumped inward, thereby creating pressure as indicated by zone 103 as it “pulls” the gas indicated at zone 102, thereby creating a boundary of mass flow potential 101 and a higher exit pressure at zone 103.

The heat exchanging system 1501 has an axis 1503 that rotates 1502 two pairs of wheels 1506 and 1507 together which moves the mass flow outward 1405 and back inward 1509 toward the center 1503 for exit by a continuous masstubarc flow siphon 1508. The compressed mass 1510 moves toward the heat exchanger 1512 where the compressed mass expands 1511 absorbing heat in the device. The decompressed mass moves back 1513 by the containment 1514 for another heat exchanging cycle. Such a heat exchanging system can expanded its performance by adding a module an outer case or point 1521.

FIG. 15B illustrates a horizontal cross-sectional view of a dynamic modeling of optional adding pumping modules to a heat exchanging system using reversible molecular rotating pump with masstubarc flow siphon by non-partitioning flow movement. Expansion of the pumping performance is attained by increasing modules of working parts. One simple additional unit has an outer case 1515, an axis 1520, and two rotating wheels. The first wheel 1517 force the mass outward by the masstubarc flow siphon 1516 while the second one 1518 force the mass inward by another masstubarc flow siphon 1519 in serial connection.

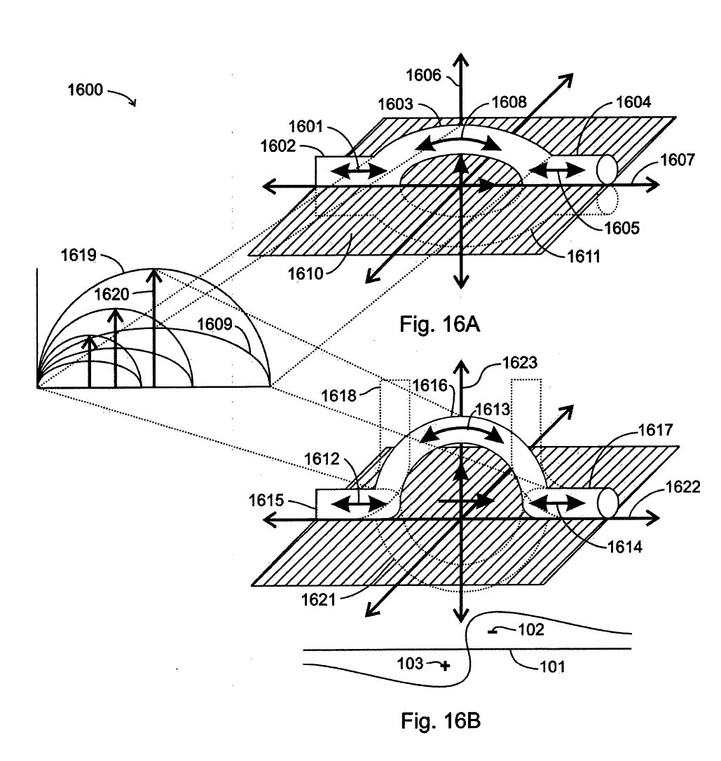

When an inertial force exchange occurs due to an unbalanced rotating force, a strong transversal vector can result from the smooth conversion in rounded or curved surfaces thereof. FIG. 16A illustrates a lateral view of spatial dynamic modeling application of forces of an unbalanced reversible masstubarc flow siphon to exchange energy between inertial and rotating forces by non-partitioning flow movement for navigation. The masstubarc flow siphon disclosed herein with respect to particular embodiments can possess two linear opposite sides 1602 and 1604 joined by an arc segment 1603 assembled over a planar area 1610.

Air can reversibly enter the siphon in one end 1601 or the other opposite end 1605 thereof. As the air passes through the arc segment 1603, the air mass flow exchanges energy between inertial forces to rotating forces as it moves as indicated by arrow 1608. A balanced reversible masstubarc flow siphon 602 such as that depicted in FIG. 6A can compensate the lack of balance to a rotating motion when two unbalanced masstubarc flow siphon are assembled diagonally in a rotating wheel, which is not the case depicted at area 1611. The unbalanced masstubarc flow siphon depicted in FIG. 16A can convert the inertial energy in the mass flow (i.e., see arrow) 1607 to lateral motion (i.e., see arrow 1606) which can provide lift, for example, to an aircraft. The size of the arc 1609 can vary according to the energy level required to exchange energy between inertial and rotating forces.

The curvature of the configuration depicted in FIG. 16A is similar to the format of the cross-section of an airplane wing, which is appropriate for developing airlift. Reducing the curvature (i.e. see curved line 1619 in association with arrow 1620) of an unbalanced masstubarc flow siphon can actually result in a balance of centripetal and centrifugal forces toward a neutral force design evidenced by curve 1609 which would provide the minimum tangential motion in the reversibility. If this holds true, the round format in the cross-section of a wings for lift may take advantage of neutral forces in the boundaries of reversibility, where a moving mass about the arc does not suffer energy losses due to compensating rotating forces.

Consequently, a frontal vector may change direction to provide an upward lift vector with high energetic efficiency in the conversion process. For the rotating wheels this would be the boundary between reversible and nonreversible masstubarc flow siphons. The segment 1603 seems to function in a manner similar to that of a concave curved surface having a negative acceleration downward. This conception may not apply to all cases at the same differential acceleration. Simple experiments gauging the parameters can confirm which approaches are more efficient to specific applications for product development.

FIG. 16B illustrates a lateral view of a spatial dynamic modeling of forces of an unbalanced reversible masstubarc flow siphon to exchange energy between inertial and rotating forces by non-partitioning mass flow for energy harvesting. The mass flow comes inside from the linear segment of the masstubarc flow siphon 1615 flowing form the left 1612 or 1617 flowing from the right 1614. As the mass flow passes through the arc segment 1616 the mass flowing 1613 delivers part of its inertial energy 1622 as rotating energy 1623. Then, the mass passing through the reversible masstubarc flow siphon delivers energy 103 when coming from the right in the mass potential graphic, changing the boundary of energy potential in the system 101 as the mass exits with less energy 102 as it had previously.

The inertial energy exchange in FIG. 16A and FIG. 16B seems to posses an initial vector that changes direction at indicated by dashed lines 1618. Then it would move tangentially to the arc part of the masstubarc flow siphon which is different form the skier in motion trying to stop delivering his inertial energy to a gradual curve FIG. 4A. Both FIG. 16A and FIG. 16B work like an unbalanced masstubarc flow siphon 1621 with a ninety degree inertial changes prior to arc motion as indicated by dashed lines 1618 thereafter for energy exchange principles between inertial and rotating forces by non-partitioning mass flow.

In attempting to explain the concepts discussed herein, reference may be made to biological analogies, such as that of a bird. A gliding bird, for example, can remain afloat for hours in high altitudes collecting inertial energy from the moving mass and transforming it for lift support. Similar approaches can be applied to vehicles, such as cars, airplanes, rockets, boats, etc.

The mass passing through the vehicle can be converted to a transversal vector for lifting or maneuvering support. Modern moving machines can be combined with enhanced propulsion and transversal vector support for navigation. In such cases, “flying cars” or airplanes for terrestrial transport becomes increasingly feasible due to the reduction of wing span, because the entire body of the flying object may interact with a moving mass and promote lifting support and special maneuvering. Such configurations may result in much lower speeds required for the lift support, or gliding, as the unbalanced reversible siphon offers a technological edge for converting an inertial force to a rotating force.

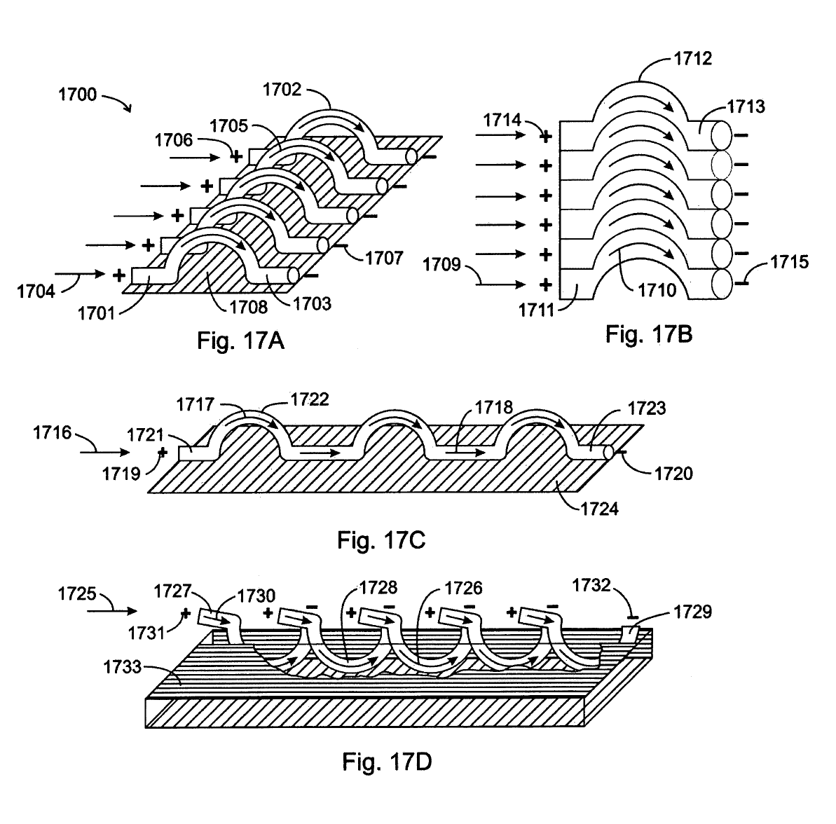

FIG. 17A illustrates a lateral view of a spatial geometric modeling of unbalanced reversible masstubarc flow siphons in parallel upward vector assembly to exchange energy between inertial and rotating forces by non-partitioning flow movement for perpendicular traction. The mass flow 1704 enters the reversible masstubarc flow siphon at the linear segment 1701. Then, the mass turns to the rounding segment 1702 when the mass flow 1705 exchange inertial energy to rotating energy decrease its potential energy 1706 to a lower level 1707 as the mass leaves by 1703.

Because such a masstubarc flow siphon is generally unbalanced, the rotating energy creates an upward vector of motion related to the plan 1708. The unbalanced reversible masstubarc flow siphons can be assembled closely to one other to take advantage of the moving mass during the process of converting inertial energy to rotating energy. The plan 1708 can be configured as a component of a turbine or windmill transforming its transversal vectoral power to rotating energy in a rotating device, or can simply form part of an outer layer of a moving machine delivering lifting power or navigational support. A bulky assembly can optionally be implemented to add features for exploiting thicker layers of moving mass about the object, which can becomes an important feature for allowing portability and the consequent reduction of wing span by the concentration of a working load.

FIG. 17B Illustrates a lateral view of a spatial geometric modeling unbalanced reversible masstubarc flow siphons in a bulky parallel upward vector assembly to exchange energy between inertial and rotating forces by non-partitioning flow movement for perpendicular traction. The bulky assembly would allow collecting most energy from the moving mass passing through the reversible masstubarc flow siphons.

The potential mass energy content 1714 reduces to a lower level 1715 as the mass 1709 enter the linear segment of the masstubarc flow siphon 1711 and changes direction on a uniform arc feature 1712 as the mass flow 1710 exchange inertial energy to rotating energy providing an upward direction as unbalanced reversible masstubarc flow siphon. Consequently, the moving mass exits 1713 the masstubarc flow siphon with lower level of potential energy creating an upward lift or force. It could be a rotating movement if assembled to a moving part. In a bulky serial or parallel assembly the masstube flow siphon can have optional squared formats instead of rounded, if the manufacturing approach turns out to be more practical and does not impair the hydrodynamic functioning thereof.

Aircrafts flying at very high speeds (e.g., transcontinental flights) may benefit from a serial assembly of a reversible masstubarc siphon if a unique arc proves not to enough to collect enough power from the inertial force. FIG. 17C illustrates a lateral view of a spatial geometric modeling unbalanced reversible masstubarc flow siphons in a serial continuous upward vector assembly to exchange energy between inertial and rotating forces by non-partitioning flow movement for perpendicular traction. When the potential energy 1719 in the moving mass flow 1716 is too high to be collected in just one rounding segment of masstubarc flow siphon, multiple serial continuous assembly would allow reducing the energetic level even more 1720 providing a longer lagging time and spatial distribution for the inertial energy to convert to rotating energy.

The moving mass can enter the linear segment of masstubarc flow siphon at point 1721 and pass through one or more arc segments 1722 to allow the flow to exchange energy between linear forces 1718 and rotating 1717 forces, departing at point or area 1723. The collection of inertial energy and transformation to rotating energy would create uplift and/or rotating motion to the 1724 plan according to the assembly design for the masstubarc flow siphon for each specific application employed.

Sometimes it may be a practical to insert the masstubarc flow siphons into the walls of the moving machine, thereby converging the vector power towards its core and providing a high level of stability, or lift, if properly assembled upside-down in the bottom thereof. An aircraft flying at 5 or 10 thousand kilometers per hour, for example, may take advantage of such aerodynamic applications.

FIG. 17D illustrates a lateral view of a spatial geometric modeling with unbalanced reversible masstubarc flow siphons in a serial intermittent downward vector assembly to exchange energy between inertial and rotating forces by non-partitioning flow movement for perpendicular traction.

Intermittent assembly might be useful to the outer layers of air or hydro vehicles providing more stable navigating motion as the moving vehicle gets a higher adherence interaction with the passing masses making it compress to itself for lateral assemblies or lift if in the assembled upside down at the bottom of a moving vehicle. Moving masses 1725 passing through each masstubarc flow siphon 1727 reduces its mass potential 1731 to a lower level 1732 adding a perpendicular push downward to the plan 1733. The mass flow enters 1730 by the linear segment of the masstubarc flow siphon 1727 and exchange inertial energy in the arc segment 1728 as it flows (e.g., see arrow 1726) smoothly exchanging energy between inertial and rotating forces, and exits at point 1729.

The dynamics of a moving mass can be improved by reducing the turbulence caused by overlapping in the path which results to noise and losses of energy. The hissing sound of blowers, cars, airplanes, etc. becomes annoying and unpleasant in many cases causing deep human discomfort. Energy losses in a continuous pumping or impulsion system due to disruption of molecular connectivity are sources of sound pollution and a waste of energetic resources.

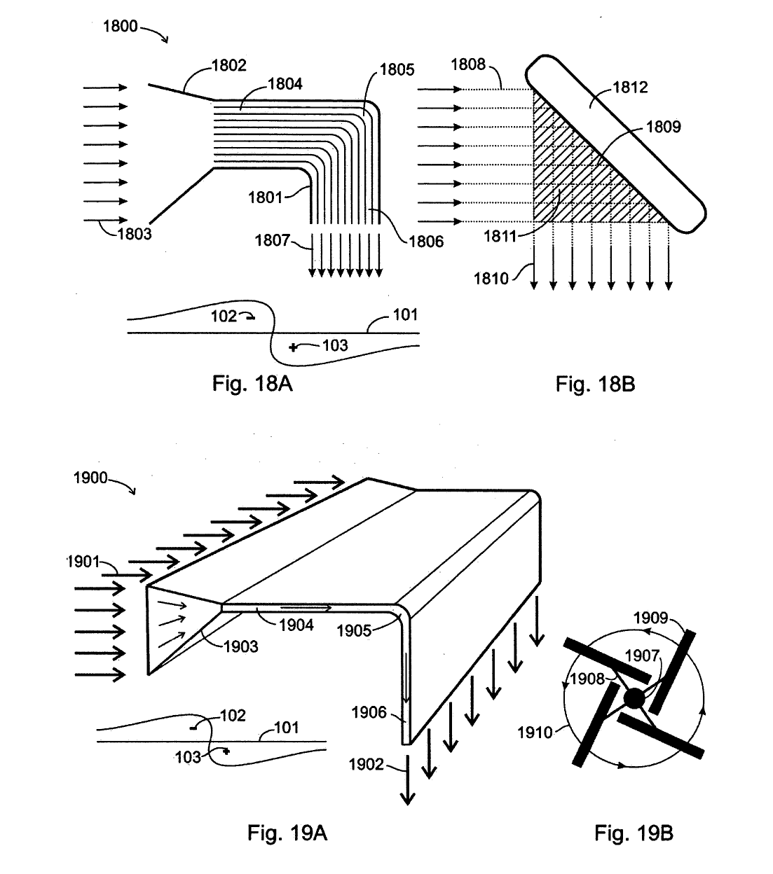

FIG. 18A illustrates a cross-sectional view of a system 1800 that includes spatial geometric modeling of an unbalanced reversible masstubarc flow siphon 1801 in parallel assembly to change direction of inertial forces and rotating forces by non-partitioning mass flow movement. The masstubarc flow siphon 1801 changes direction of an incoming mass 1803 entering siphon 1801 through an optional opening 1802 that acts to compress the mass even more, thereby concentrating it as the potential energy increases (i.e., see zone) 102 in the turning process and concentration (i.e. see zone 103). Rotating energy can also be added, thereby affecting the potential energy boundary 101.

The mass flow enters a linear segment of the masstubarc flow siphon and flow through a central portion 1804 thereof. Thereafter, the mass makes an arc turn 1805, thereby absorbing rotating energy while continuing to flow in a linear outlet segment 1806 to exit the masstubarc flow siphon 1801 in a non-partitioning movement represented by arrows 1807 with a higher energy potential (i.e., see zone 103). FIG. 5 provides some insights into several options that may be implemented for using a ninety degree turn of the masstubarc siphon for non-partitioning mass flow. Also, input and output of mass can provide opposite directions for propulsion, wherein input occurs at the head and output at the tail of linear masstubarc siphon such as that depicted in FIG. 4C, which can be configured as combination of two ninety-degree turns.

FIG. 18B illustrates a cross-sectional view of a spatial geometric modeling of a traditional turbulent system compared to unbalanced masstubarc flow siphon in parallel assembly to change direction of inertial forces and rotating forces by non-partitioning flow movement. A conventional system can utilize propeller, impellers, vanes, paddles, and runners 1812 to cut and change the direction of the moving mass flow represented by arrows 1808, while also providing an incident angle of impact 1809 that rebounds in a ninety-degree angular direction 1810, thereby creating a turbulent zone 1811 as the income mass crosses through an outcome rebounded mass. This is the source of noise and turbulent motion in most current systems, which wastes energy during the exchange process of converting rotating energy to inertial energy and vice-versa. As wider is the device 1812 as larger becomes the turbulence, noisier and more wasteful of energy. It happens because there is a larger conflict of moving mass crossing each other as input 1808 and as output 1810.

Blowing mass can be utilized for regular fans as well for propulsion depending on the mass movement. FIG. 19A illustrates a lateral view of a system 1900 that includes spatial geometric modeling of a fan with an unbalanced reversible masstubarc flow siphon in a parallel assembly to change direction of inertial forces by non-partitioning of mass flow movement. In the configuration of system 1900, air mass moves in a direction represented respectfully by arrows 1901 to 1902. The air mass can be compressed optionally by a large entrance 1903 as it enters a straight segment of the masstubarc flow siphon 1904.

Thereafter, the air mass can make a ninety degree turn at a curved portion 1905 and exit the fan by a straight segment 1906 of masstubarc flow siphon 1904. The air mass potential changes from a lower level (i.e., see zone 102 to an increased level (i.e., see zone 103) thereby affecting an imaginary boundary 101 by compression of the mass flow through entrance 1903 and/or via kinetic/mechanical energy added through the rotating motion of the fan. The smoothness of the rounding curved portion 1905 may further reduce possible hissing sounds associated with the abrupt molecular change in the mass direction. This system may provide even more propulsion power and lift for avoiding turbulence as well as concentrating mass flow. This is another important technological edge enhancement of the present invention, thereby providing solutions that allow airliners and helicopters to fly at higher altitudes with very low density air support.

FIG. 19B illustrates a downward view of a spatial geometric modeling with tangential correction of a fan with an unbalanced reversible masstubarc flow siphon in parallel assembly to change direction of inertial forces by non-partitioning of mass flow movement. In this case the fan rotates in a counterclockwise direction, as indicated by circular arrow 1910, thereby moving paddles 1909 assembled with multiple parallel masstubarc flow siphons which have a support 1908 connected to a rotating center 1907. The paddles can be turned thirty degrees forward at their referential center to the acceleration force in order to reduce the inward motion of centripetal forces, thereby providing a smoother distribution of mass flow working in a circular fashion. This correction aims to improve the overall air movement mainly the outer boundary with higher mass flow and larger torque due to the radius increasing outwardly.

A differential gradient of sunlight is associated with heat during the day and changes at night, when land and water bodies are cooled. Such a phenomenon can also be a continuous source of energy for coastal breezes, which can be collected and converted to rotating energy for many uses, mainly electricity generation. A moving mass can deliver its mechanic/kinetic energy, or at least part of it, as it passes throughout the rounding portion of a masstubarc siphon. The inertial energy delivered can be converted to rotating energy utilizing the most appropriate masstubarc siphon shape.

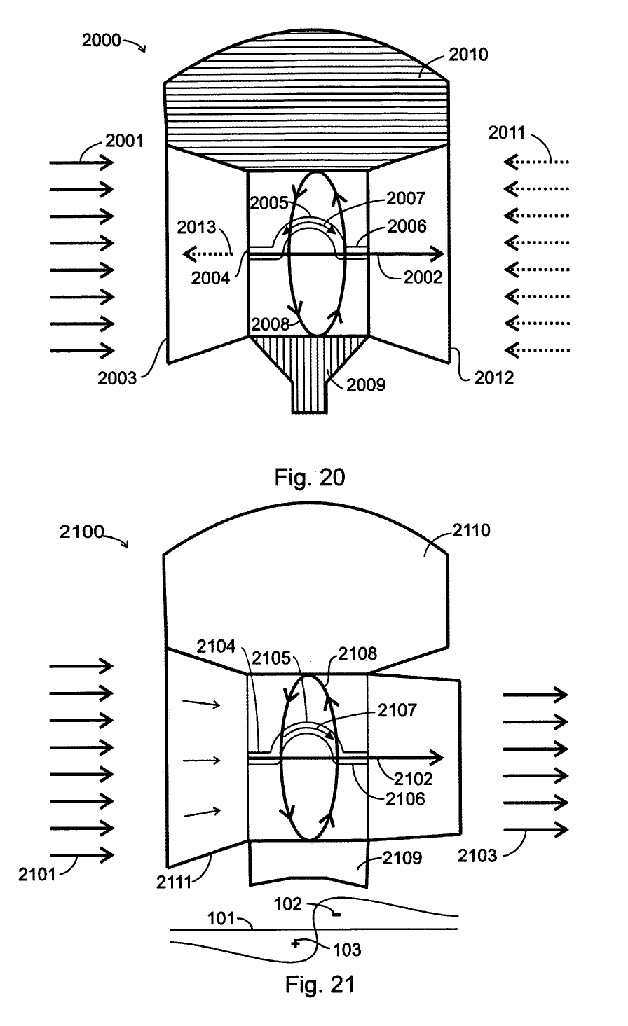

FIG. 20 illustrates a cross-sectional view of a system 2000, including spatial geometric modeling of a molecular windmill using unbalanced reversible masstubarc flow siphons with non-partitioning flow movement. System 2000 therefore functions as a molecular windmill. Moving air masses as indicated by arrow 2001 move toward the molecular windmill at the entrance thereof, which comprises an optional funnel 2003 that concentrates the air mass as it passes through a linear section of an unbalanced masstubarc flow siphon 2004. A single windmill can possess many masstubarc flow siphons in several formats assembled in parallel or serial in order to best collect the inertial energy of a moving mass and converting such inertial energy to a rotating force. The mass can then continues flowing as indicated by arrow 2007 as it moves along an arc segment 2005 of the masstubarc flow siphon 2004, thereby delivering its inertial energy in counterclockwise turning direction as indicated by circular arrow 2008.

After passing through the arc segment of the masstubarc flow siphon 2004, the moving mass exits it via a linear segment 2006 and flows away as indicated by solid arrow 2002 and outlet 2012. The flow can be reversible letting the mass flow 2011 enter in the other side 2012 and exit at point 2013, delivering the inertial energy 2007 at point 2005 with the same vectoral direction (i.e., see arrow 2008) turning counterclockwise. This reversibility might be important when the wind changes direction too fast to be corrected by the directional vane 2010.

The potential mass energy can be reduced from a higher level (i.e., see zone 103) to a lower level (i.e., see zone) 102 according to an imaginary boundary 101 of energy exchange. The molecular windmill of system 2000 includes a stationary support with a turning compartment 2009 that permits a vane 2010 to align the entrance according to the direction of prevailing winds in order to harvest the maximum possible inertial energy from the wind. The turning compartment 2009 also can possess optional gears to harvest the rotating energy for transformation to other usable forms, such as for example, an electric generator. Other formats of masstubarc flow siphons are possible and can be employed in accordance with the best performance achievable for each specific field condition.

When the moving mass has a higher density (e.g., as in the case of water), a higher level of inertial energy can be collected compared to wind. Turbines for collecting inertial energy from moving water for conversion to rotating energy can be implemented in the context of a stationary or a floating device that collects rotating energy from a moving river and for attending moderate demands thereof. It is important to note that floating turbines could be very important to running rivers on lowlands or tidal coasts where damming is not feasible, such as in the low lands of Amazon region. The Amazon River drops, for example, approximately 192 m from Manaus to Belem after running approximately 2,000 km to empty in the Atlantic Ocean.

FIG. 21 illustrates a cross-sectional view of a system 2100, including the spatial geometric modeling of a molecular turbine thereof utilizing an unbalanced reversible masstubarc flow siphon with non-partitioning flow movement. The molecular turbine implemented by system 2100 can be implemented as floating element that harvests inertial energy from moving water via a floating device 2110, or can be part of a piped system working on water from a dam. The molecular turbine of system 2100 can utilize other designs of reversible masstubarc flow siphon in a balanced fashion. Assembling techniques will determine the best features for each application accordingly.

Water mass flowing toward the molecular turbine of system 2100 as indicated by arrows 2101 can enter the turbine by an optional funnel 2111 that concentrates the flow toward a rotating wheel 2108. Water enters the turbine as indicated by arrows 2101 by a linear segment of a masstubarc flow siphon 2104 and then moves along to the arc segment 2105 of masstubarc flow siphon, where inertial energy is exchanged from a higher mass potential level (i.e., see zone 103) to a lower mass potential level (i.e., see zone 102) as indicated by the boundary 101 of energetic change. The mass flow continues as indicated by arrow 2107 toward an exit 2102 that passes by a straight segment 2106 of the masstubarc flow siphon. The mass flow thereafter exits the system 2100 (i.e., the molecular turbine as indicated by arrows 2103). A compartment 2109 is located at the bottom of the molecular turbine where appropriate gears are located to transform the rotating energy (represented by circular arrow 2108) of the turbine into electricity or any other use of the rotating power collected.

Mass flowing at high speed and/or pressure can benefit from a spring-like system to harvest inertial energy and transform it into rotating energy on a rotating device. Such application could be designed to operate on piped water from dams collecting inertial energy with non-partitioning flow movement. As in the symmetry of pumping operations, when energy is added to the moving mass, the rotating energy added can result in suction for mass input and pressure for mass output. Thereafter, the reversible masstubarc siphon can collect all potential inertial energy from the input flow by pressure and output flow by suction when the mass passes downward through the molecular turbine. Such a situations means that water, even leaving the turbine, can release inertial energy by suction, because the molecular connectivity is preserved.

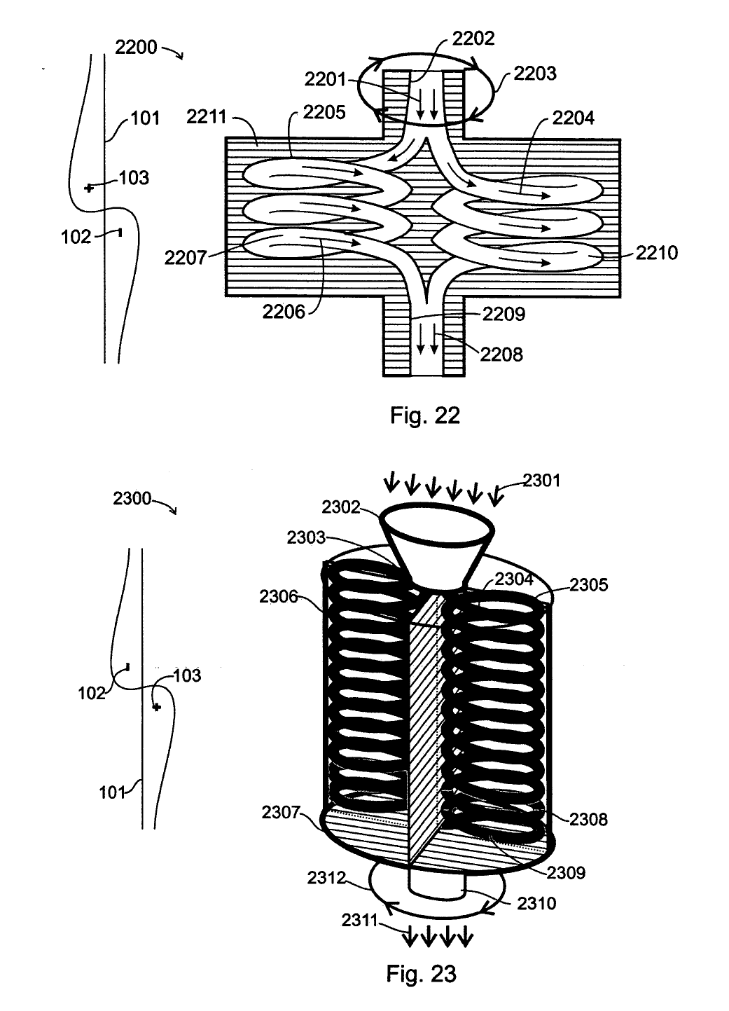

FIG. 22 illustrates a cross-sectional view of a system 2200, including spatial geometric modeling of a molecular turbine 2211 thereof using a balanced reversible masstubarc flow siphon 2205 with non-partitioning mass flow movement. Molecular turbine 2211 can be configured so that one or more balanced masstubarc flow siphon 2205 can be assembled as a pair of a spring-like serial composition 2210 and 2207 as long as necessary to harvest most of the inertial energy for each application. A moving mass 2201 enters the molecular turbine 2211 as indicated by arrows 2201 at a straight segment 2202 of siphon 2205. Thereafter, the mass flow splits to the arc segments of siphon 2205, where the inertial energy is transformed to rotating energy 2203 as the mass moves along at the outward motion, as indicated, for example, by arrow 2204.

The mass flow moves inwardly as indicated by arrow 2206 for example in the last rounded segment 2207 of the masstubarc flow siphon 2205, and thereafter achieves a linear motion, as indicated by arrows 2208 within a straight segment 2209 of siphon 2205. The mass can then exit 2209 the molecular turbine 2211. System 2200 can implement a balanced molecular turbine, which is reversible and moves a mass that passes through it, such that a potential energy thereof is changed from a higher level (e.g., zone 103) to a lower level (i.e., see zone 102) in the boundary 101 of energy exchange of the reversible masstubarc flow siphon 2205. The masstubarc flow siphon 2205 can thus be configured in the format of a spring-like serial composition 2210 and 2207, which provides variable arc dimensions at the inward flow 2206 in order to allow a smooth energy conversion from the inertial to rotating forces at a desired maximum efficiency.

When a certain portion of moving mass receives a high level of kinetic/mechanic energy by rotating forces with non-partitioning movement, a high level of suction and thrust can be expected from the device when turning at ultra-high speeds because it develops a different and unique interface with the mass preserving molecular bond. FIG. 23 illustrates a lateral view of the spatial geometry of a molecular propulsion system 2300, which can utilize a multiple reversible masstubarc flow siphon by non-partitioning mass flow movement for aerodynamic and hydrodynamic applications. Moving mass flow can be sucked as indicated by arrows 2301 into the entrance of the molecular propulsion turbine 2307 through the use of optional funneling feature 2302 concentrating the mass.

System 2300 can include one or more masstubarc flow siphons 2303, which are arranged in a spring-like sequence. As the mass enters the masstubarc flow siphon 2303, which is configured in a spring-like sequence of serial siphons outward 2304 and inward 2305 the mass flow moves, thereby altering the energy mass potential differential 101 from a low level (i.e., zone 102) to a very high level (i.e., zone 103). At the bottom, the last masstubarc flow siphon can possess an optionally smaller diameter 2308 and 2309 to increase the mass compressibility increasing the push power as the mass exits (i.e., as indicated by arrows 2311) the molecular engine by the last linear segment of the masstubarc flow siphon 2310. The propulsion engine 2307 can possess many sets of spring-like pairs of masstubarc flow siphons 2306 to match each type of application.

The rotating power indicated by circular arrow 2312 can be derived from an external source, such as, for example, a molecular propulsion turbine functioning as a propeller device for propulsion during aerodynamic or hydrodynamic applications, thereby providing an interface of thrust to the external mass. Each pair of balanced inward 2305 and outward 2304 masstubarc flow siphons can possess arc dimensions appropriate to put together an expected sequence of energy exchange between inertial and rotating forces in order to attain the best performance possible. The thrust potential is very impressive when the moving mass absorbs all motion from the rotating masstubarc siphon speed. For example, a 2 meter diameter turbine rotating at 50,000 rpm would develop a maximum circular outer speed of 18,850 km/h, suggesting that the performance of molecular propulsion may possess unpredictable boundaries of achievement.

The masstubarc flow siphon offers a different feature to handle air masses at large velocity by non-partitioning movement. Then, propulsion can have a different approach reaching high performance at low noise and more efficient energy conversion ratios. Molecular propulsion system can operate at very high rpm because it has the principle of non-partitioning and a unique moving part which comprises the masstubarc flow siphons canalizing masses.

A molecular combustion engine can be implemented as a simple combination of a pump plus a turbine having in the middle thereof, a segment of ultra high temperature to deliver all of the latent chemical energy of the biomass fuel. Liquid or solid fuel heated above 600° C., for example, can burn spontaneously and instantaneously. Increased temperatures can make the engine more efficient, toward a complete combustion of varied fuel conditions. The pump moves forced air in as a mixture of carburant and fuel. The fuel can be liquid or solid. Fuel can be supplied as required for engine performance.

Liquid fuels are especially important until the engine warms sufficiently for easier combustion of solid fuel, and perhaps also to supply fast required torque for acceleration. The forced air pumped inward can carry fuel that burns, while permitting an expansion of gases, which can develop heat while generating fast flow of the moving mass. The turbine can collect most of the thermal and inertial energy from the combustion process and change it to rotating energy, which can be also utilized to pump air and fuel inward. Other uses include vehicle movement, electricity generation, air conditioning, hydraulic power, and grinding of solid biomass fuel.

A reversible masstubarc flow siphon can offer many features for achieving the goal of harvesting energy from chemical combustion in a continuous process. An arc arrangement can result in the collection of inertial energy and increasing dimensions of mass flow through tube as the tube flow absorbs heat, which is similar, for example, heat exchanger. A simple molecular combustion engine can therefore be composed of a unique block portion that contains an adequate pump for air input and a turbine for air output. The turbine collects the potential mass energy, thereby transforming such potential mass energy to rotating energy, which can be utilized as power source for its own functioning, as well as for air and fuel feeding. Additionally rotating energy can result in the generation of power and electricity for general applications to vehicles or any other stationary work.

The common cycle of a combustion engine is approximately 2,000 rpm, which would provide approximately 33 turns per second. If four cylinders strike individually, such a configuration can lead to about approximately eight explosions per second per cylinder. In the case of 2.0 engines, such an engine can distribute 500 ml per piston while striking eight times per second a second to generates 8 liters of compressed hot air. Because the air compression and combustion is constant and the molecular engine is not required to wait for valves to close and open, a molecular engine as described herein can operate effortlessly within a range of approximately 20.000 to 50.000 rpm, thereby providing extra time and spatial arrangement for force conversion between inertial energy and rotating energy.

In this case, the power can be delivered from one turn of a conventional explosive combustion engine and can be replaced by a similar power from 10 turns of a molecular combustion engine. If more power is required for example, for trucks and large workloads, the same engine could rotate 20 or 30 times more. Consequently, this new approach changes the conception of torque of conventional engines if the rotating speed can vary so broadly, thereby allowing a larger volume of hot air and fuel combustion to deliver more rotating power by time. Solid fuel may not represent a major concern if special care is taken to prevent clogging and ash collection in the exhausting pipe, because there are no moving parts inside the engine.

Regular biomass usually contains around 60% to 80% water that after drying would have an increased porosity, and consequently volume. Utilizing powder or pellets, however, could provide a solution for supplying solid fuel at a constant rate for combustion processes according to each specific mechanical design. Larger engines would accept larger granularity in the solid fuel. A chopper or grinding device assembled in the vehicle can be configured to accept a broad range of organic solid fuel in order to break the fuel into particle sizes small enough for the molecular engine feeding. Even a vehicle slowing down can collect inertial energy in the halting process for grinding the solid fuel.

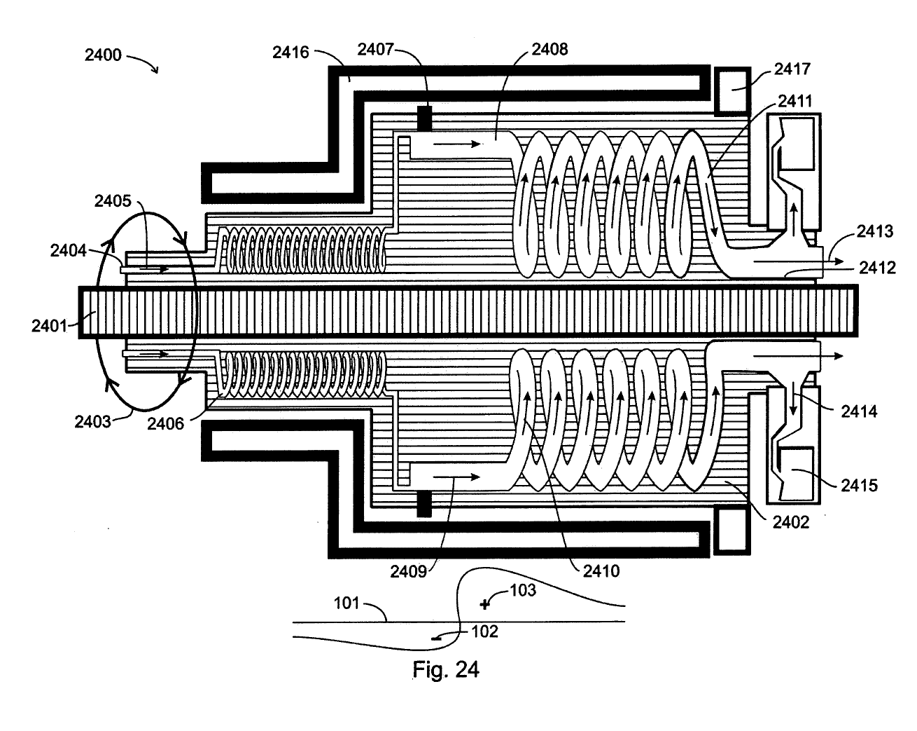

FIG. 24 illustrates a cross-sectional view of a spatial geometric modeling of a system 2400 that functions as molecular combustion engine, which incorporates a reversible masstubarc flow siphon by non-partitioning mass flow movement for solid and liquid fuel. The amount of energy potential in the moving mass increases from a very low level (i.e., see zone 102) to a higher level (i.e., see zone 103) due to combustion, which releases chemical energy in the molecular bonding of organic matter affecting the boundary 101 of energy potential and exchanging inertial energy in the expanding gases to rotating energy. The molecular combustion engine of system 2400 possesses a main rotating block 2402 that rotates about an axis 2401 of a central portion. As it turns, as indicated by circular arrows 2403, a composition of two sets of serial masstubarc flow siphons move masses of air with fuel in by a reversible masstubarc flow siphon of a spring-like pump 2406 and combustion gases out through reversible masstubarc flow siphon 2411 of a turbine like device.

A mixture of air and/or liquid/solid fuel can enter the engine of system 2400 at an entrance to reversible masstubarc flow siphon 2404 by the linear masstubarc flow siphon segment 2405 sucked by a series of spring-like connected siphon(s) 2406. A spark plug 2407 can provide a continuous or intermittent source of spark/heating to maintain or start the combustion, while fuel and oxygen can be utilized to maintain a constant combustion at the combustion chamber 2408, thereby permitting air to expand several times as the chemical energy from a burning biomass 2409 adds enormous inertial motion and heat to the moving mass. The combustion chamber 2408 also can be located near the center 2401 and possess higher dimensions if required for improved performance. Also, the combustion chamber 2408 can possess different features like secluding walls or grooves to delay or speed up the combustion process.

As the expanding mass moves in the linear segment of the combustion chamber 2408, it can deliver the inertial energy 2410 in the arc segment of the reversible masstubarc flow siphons 2411, thereby adding rotating motion 2403 to the engine. As the hot air mass exits the molecular combustion engine as indicated by arrow 1413 by the straight segment of the masstubarc flow siphon 2412, the continuous rotating motion applied removes dust outward (i.e., see arrow 2414) to a special collector 2415 to prevent the engine from releasing ashes to the environment. In order to increase the engine thermal efficiency, an outer isolation layer 2416 can be employed to prevent heat losses. The molecular engine also can possess a gear 2417 for rotating power transmission.

Efficiency in the process of energy exchange between inertial and rotating forces for molecular engines can be favored by a variable increasing or decreasing diameter in any segment of the masstubarc flow siphon 2406 and 2411 in order to compensate for expansion and contraction of the moving mass thereof. The end portion of the masstubarc siphon 2411 can be optionally configured to possess a decreasing cross-sectional diameter to compensate for air contraction due to temperature reduction and continuing losses of inertial power. A similar approach of reducing the diameter of the masstubarc siphon 2406 in the operation of air and fuel input might avoid clogging the feeding system thereof. Variably increasing or decreasing the diameter of any masstubarc siphon can also provide an enhanced geometrical dynamic feature that splits kinetic and mechanic forces in the moving mass and which can be exploited accordingly depending upon the application thereof.

Utilizing a molecular combustion engine operating with non-partitioning masstubarc flow principles as described herein provide very practical benefits to vehicle driving maneuverability. A highly variable rotating speed developing a range of torque may dismiss gear systems, because such principles, when applied to vehicles can provide increases in power over time by a higher input of fuel and higher rotating speeds. Also, a molecular engine can be halted to a zero rotation for stopping purposes, with no further consequences to its functioning because the mass flow is continuous, delivering torque as a “stuck engine”, because the exiting burning mass maintains pressure in the rotating arcs. As the break pedal is released, the motion starts over, returning to its previous rotating condition. The molecular engine does not “choke” like conventional combustion engines. A clutch would likely not be necessary unless to let the engine rotates freely for other rotating power requirements in the vehicle. Finally, a vehicle operating with a molecular engine may require only a steering wheel and another pedal, which may possess multiple functions for completely controlling the vehicle motion, such as stopping or increasing or decreasing speed. A single push button could also be implemented in order to change the rotating direction for rear vehicle maneuvers.

The solid fuel can be fed to the moving mass for combustion in the molecular engine as a dry powder or fine pellets, fresh or charred depending on the burning requirements. Energy balance experiments can provide information to gauge the ratios of various types of fuel and carburant, as well as the dimensioning of the masstubarc flow siphons for pumping in air plus fuel and turbining out the expanding air mass. A unique molecular engine can possess multiple input path 2405 options for each kind of fuel. A single engine could, for example, provide input paths assigned for solid, liquid, and gas, and their varied combination. Also, fuel can be added to the air input, meaning that latent heat still can expand cool air and generate power output in the mass output flow. Choking the input flow would let the engine rest the stored energy momentarily, while maintaining the heat thereof until a workload is required again (e.g., slow moving traffic).

Tropical soils such as those found in the Amazon are the most fertile, and ideally suited for high biomass production. A combination of warmth, rainy regimes and sunlight throughout the year enhances biomass production. Such areas can produce approximately 20 tons of biomass per year per hectare as dry matter basis. If a kilogram of biomass can deliver the same compensatory work as 1 liter of gasoline on a biomass molecular engine, then one hectare would produce a biomass per year yield equivalent to 20,000 l of gasoline, which could run a car 200,000 km at a base of 10 km/kg of DM of biomass. This represents a sustainable energy system for human use in the future. Additionally, such biomass production capabilities would not threaten the environment because decomposing biomass could be used for energy resources. The production of biomass fuel could be much more sustainable than present modern agriculture purposes. A huge amount of biomass from the trimming of plants in the landscape, as well from the agricultural lands as byproducts is typically wasted to simple decomposition.

Biomass fuels can be standardized according to their energy level and physical form. Consequently, all biomass fuel could be labeled with the letter ‘B’. Energy levels could be graded based upon multiple (thousand) units of kcal per kilogram of dry matter, thereby providing a decimal equivalent to the three figures of gross energy content. Usually the energy increases proportionally to the increased ratio of fat content. A biomass fuel graded as B4, for example, can comprise a biomass having from 4 to 5 kcal/g.

A liquid biomass fuel label can include the addition of the letter ‘L’. For example, palm oil could be a biomass fuel designated as B9L, meaning that it comprises a liquid biomass fuel containing gross energy between 9 and 10 kcal/g. Methanol would be B6L. Higher caloric content could result in a higher power, thereby making such fuel more valuable in the market range. Purchasing biomass fuel can be based on the gross energy deliverable per weight unit. Current systems for fuel labeling are distorted because gasoline labeling, for example, does not expressly state how much additional energy per unit of volume can be expected with a compensatory higher price, if any at all.

Another advantage of the particular embodiments of the present invention, involves food production systems. Present food production systems nurture a deep inconsistency with respect to energy balance and two interrelated prominent growing tribulations: energy depletion and the recently worldwide increasingly problem of human obesity. Instead of producing food for an overeating human population, food production systems could be utilized to produce biomass fuel for in effect “feeding” more efficient engines. The document “Nutrient dynamics between human nutrition and food production systems” by Silva, E. D. 1999, Ciência e Cultura, 51(2):81-87, indicates, for example, that in the year 1990, the United States produced approximately 7.5 times more food than necessary for feeding its own population on an energy-basis.

Obesity is a problem of excessive energy concentration resulting from overfeeding and is the fastest-growing major health problem in the United States. Such a situation is the result of a disturbance of the energy cycle of the human body, based on spoiling of a simple balance of input and output. In the year 2000, 31% of American adults were obese, up from 23% in 1990 and 13% in 1960, according to the U.S. Center for Disease Control and Prevention. An estimated 129.6 million of adult Americans, or 64 percent of the population, are overweight or obese.

Obesity places such individuals in higher risk categories involving heart disease, diabetes, some types of cancer and various forms of disability. The food production system could produce less fattening food and diverge its core economic importance to produce biomass fuel for energy need. It has been observed that poor communities with a food supply shortage are unlikely to develop obesity consequences. Americans could eat healthier food with low calorie levels, while the food production system is altered to produce a simple burnable biomass fuel for a more efficient engine system. Finally, health and energy growing crisis can be solved, without major economic stress or hurting job opportunities, by canceling or compensating each other, bringing a balance and symmetry to nature functioning on actual demand and supply regarding the energy cycle.

Instead of utilizing fossil fuels to produce corn for transformation into methanol for fuel, farmers could crop more efficient and environmentally sound perennial or semi-perennial crops to supply biomass burning fuel. Farmers could produce their fuel crop, for example, for both human consumption and/or fuel crops, and for marketing a renewable biomass. In such scenarios, rich economies could change their international policies from a constant quest for energy resources to policies based common commodities collected anywhere the sun shines and plants grow.

The embodiments and examples set forth herein are presented to best explain the present invention and its practical application and to thereby enable those skilled in the art to make and utilize the invention. Those skilled in the art, however, can recognize that the foregoing description and examples have been presented for the purpose of illustration and example only. Other variations and modifications of the present invention will be apparent to those of the skill in the art, and it is the intent of the appended claims that such variations and modifications be covered. The descriptions as set forth is not intended to be exhaustive or to limit the scope of the invention. Many modifications and variations are possible in fight of the above teaching without departing from scope of the following claims. It is contemplated that the use of the present invention can involve components having different characteristics. It is intended that the scope of the present invention be defined by the claims appended hereto, giving full cognizance to equivalents in all aspects.

1. A method, comprising:
providing energy to a moving mass in at least one reversible direction; and
harvesting said energy from said moving mass in at least one reversible direction, by containing said moving mass for an energy exchange without partitioning said moving mass as said moving mass travels from a straight tubular zone to an arc zone thereof and back to said straight tubular zone to permit a gradual energy exchange of a tangential vector thereof.

2. The method of claim 1 further comprising:
reversibly transporting said moving mass from a low mass matric potential a high mass matric potential and from at least one position to another position thereof in a reversible direction by providing said energy via a masstubarc flow siphon under a non-partitioning mass flow.

3. The method of claim 1 further comprising:
reversibly transporting said mass from a zone of high mass matric potential to a zone of low mass matric potential and from one position to another position in association with a reversible direction by harvesting said energy via a masstubarc flow siphon under a non-partitioning mass flow.

4. The method of claim 1 further comprising the step of automatically dynamically and reversibly exchanging energy between inertial forces and rotating forces of a masstubarc flow siphon under a non-partitioning mass flow.

5. The method of claim 1 further comprising exchanging said energy utilizing a masstubarc flow siphon, such that said energy is exchangeable through said masstubarc flow siphon in a reversible path between inertial and rotating forces thereof.

6. The method of claim 1 further comprising exchanging said energy utilizing a masstubarc flow siphon, such that said energy is exchangeable through said masstubarc flow siphon in a reversible path between rotating and inertial forces.

7. The method of claim 1 wherein said energy comprises kinetic energy.

8. The method of claim 1 wherein said energy comprises mechanical energy.

9. The method of claim 1 wherein said energy comprises kinetic and mechanical energy.

10. A method, comprising:
providing energy to a moving mass in at least one reversible direction, wherein said energy comprises kinetic and mechanical energy;
harvesting said energy from said moving mass in at least one reversible direction utilizing masstubarc flow siphon, by containing said moving mass for an energy exchange within said masstubarc flow siphon without partitioning said moving mass as said moving mass travels from a straight tubular zone of said masstubarc flow siphon to an arc zone thereof and back to said straight tubular zone to permit a gradual energy exchange of a tangential vector thereof;
reversibly transporting said moving mass from a low mass matric potential to a high mass matric potential and from at least one position to another position thereof in a reversible direction by providing said energy via said masstubarc flow siphon under a non-partitioning mass flow; and
wherein said masstubarc flow siphon comprises a tubular containing structure with uniform dimensions having at least two linear sides thereof associated with inertial forces and joined by a rounding arc portion that comprises a main interface between rotating forces in order to deliver said energy to and from said inertial forces.

11. A system, comprising:
an energy mechanism for providing energy to a moving mass in at least one reversible direction; and
a masstubarc flow siphon for harvesting said energy from said moving mass in at least one reversible direction, by containing said moving mass for an energy exchange without partitioning said moving mass as said moving mass travels from a straight tubular zone to an arc zone thereof and back to said straight tubular zone to permit a gradual energy exchange of a tangential vector thereof.

12. The system of claim 11 wherein said moving mass is reversibly transported from a low mass matric potential a high mass matric potential and from at least one position to another position thereof in a reversible direction by providing said energy via said masstubarc flow siphon under a non-partitioning mass flow.

13. The system of claim 11 wherein said flowing mass is reversibly transported from a zone of high mass matric potential to a zone of low mass matric potential and from one position to another position of said masstubarc flow siphon in association with a reversible direction by harvesting said energy via said masstubarc flow siphon under a non-partitioning mass flow.

14. The system of claim 11 wherein said energy is automatically dynamically and reversibly exchanged between inertial forces and rotating forces of said masstubarc flow siphon under a non-partitioning mass flow.

15. The system of claim 11 wherein said energy is exchanged utilizing said masstubarc flow siphon, such that said energy is exchangeable through said masstubarc flow siphon in a reversible path between inertial and rotating forces thereof.

16. The system of claim 11 wherein said energy is exchanged utilizing said masstubarc flow siphon, such that said energy is exchangeable through said masstubarc flow siphon in a reversible path between rotating and inertial forces.

17. The system of claim 11 wherein said energy comprises kinetic energy.

18. The system of claim 11 wherein said energy comprises mechanical energy.

19. The system of claim 11 wherein said energy comprises kinetic and mechanical energy.

20. The system of claim 11 wherein said masstubarc flow siphon comprises a tubular containing structure with uniform dimensions having at least two linear sides thereof associated With inertial forces and joined by a rounding arc portion that comprises a main interface between rotating forces in order to deliver said energy to and from said inertial forces.
